(19) United States
(12) Patent Application Publication
(10) Pub. No.: US 2016/0027055 A1
(43) Pub. Date: Jan. 28, 2016

(54) COMBINING ATTRIBUTES FROM MULTIPLE SOURCES

(71) Applicant: NinthDecimal, Inc., San Francisco, CA (US)

(72) Inventors: Mark Dixon, Belmont, CA (US); Kevin Ching, Berkeley, CA (US); Ahmad Fairiz Azizi, Santa Clara, CA (US); Robert Abusaidi, Angels Camp, CA (US); Leonid Blyukher, Burlingame, CA (US); David Staas, Menlo Park, CA (US); Keith Kilpatrick, San Francisco, CA (US); Veronica Milenkiy, Burlingame, CA (US)

(21) Appl. No.: 14/339,329

(22) Filed: Jul. 23, 2014

(51) Int. Cl. G06Q 30/02; H04L 29/08; H04W 4/02

(52) U.S. Cl. CPC G06Q 30/0261; H04W 4/023; H04L 67/306; G06Q 30/0269

(57) ABSTRACT

Combining attributes from multiple sources is disclosed. Location data of a mobile device is received. The location data is mapped to a location boundary of a defined location. It is determined that a user profile is associated with the defined location based at least in part on the mapping and one or more location-based rules. The user profile is updated to include third-party data associated with the defined location.

### BACKGROUND OF THE INVENTION

Computer “cookies” have been used to track which websites a computer user has visited, e.g., using a browser. Browsing history information gathered using cookies has been used to select for display to the computer user, e.g., in a banner or pop-up ad, advertising content that may have been selected based at least in part on attributes of pages the user has visited. For example, a computer user who has visited web pages associated with automobiles may be more likely to have a car ad selected for display to the user.

Attempts have been made to target ads to a mobile device user based on the user's current geographic location. For example, an ad “request” sent by and/or on behalf of a mobile app being used by a mobile user may include GPS or other current location information (e.g., latitude/longitude), and an attempt may be made to serve to the mobile user for display in the context of the mobile app an ad that has been selected based on the current location information included in the ad request, for example an ad for a business that is located at or near the user's current location.

Ads also have been selected based on the content of a site the user is currently visiting or an app the user is using, and based on analyses of social media content associate with a user, such as the user's own feed or that of the user's friends, etc.

### BRIEF DESCRIPTION OF THE DRAWINGS

Various embodiments of the invention are disclosed in the following detailed description and the accompanying drawings.

FIG. 1 is a flow chart illustrating embodiments of a process to build a user profile based on information associated with locations with which the user has been associated.

FIG. 2 is a block diagram illustrating embodiments of a system to build a user profile based on location information.

FIG. 3 is a flow chart illustrating embodiments of a process to associate user attributes with defined locations.

FIG. 4 is a flow chart illustrating embodiments of a process to associate user attributes with defined locations.

FIG. 5 is a flow chart illustrating embodiments of a process to map current location coordinates to a defined location.

FIG. 6 is a flow chart illustrating embodiments of a process to provide content based on current and/or past location.

FIG. 7A is a block diagram illustrating embodiments of a location graph.

FIG. 7B is a block diagram illustrating embodiments of a location graph.

FIG. 8 is a flow chart illustrating embodiments of a process to derive user profile information from past locations.

FIG. 9 is a flow chart illustrating embodiments of a process to update a user profile.

FIG. 10 is a flow chart illustrating embodiments of a process to manage user profile data.

FIG. 11 is a flow chart illustrating embodiments of a process to update user profile data.

FIG. 12 is a flow chart illustrating embodiments of a process of determining an association between a user profile and a location.

FIG. 13 is a flow chart illustrating embodiments of a process of determining an association between a user profile and a location.

FIG. 14 is a flow chart illustrating embodiments of a process of determining an association between a user profile and a unit in a multi-unit defined location.

FIG. 15 is a flow chart illustrating embodiments of a process of deterministically matching devices and/or profiles.

FIG. 16 is a flow chart illustrating embodiments of a process to generate location boundary data.

FIG. 17 is a block diagram illustrating embodiments of a location graph.

FIG. 18 is a flow chart illustrating embodiments of a process to update a user profile.

FIG. 19 is a flow chart illustrating embodiments of a process to update a user profile.

FIG. 20 is a flow chart illustrating embodiments of a process providing user profile data to a third party.

FIG. 21 is a flow chart illustrating embodiments of a process of generating a direct mail advertisement.

FIG. 22 is a flow chart illustrating embodiments of a process of linking offline advertising information and advertising measurement/attribution information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Building a profile of a user based on the user's location history is disclosed. In various embodiments, demographic and/or behavioral profiles associated with a user's current and/or past location(s) are attributed to the user. For example, in some embodiments a location data, such as a latitude/longitude or other location identifying information, may be received, e.g., in an ad request from an anonymous or a previously known user. When the ad request comes in, the location is mapped to a business or other place of interest, a zip+4 code, etc. One or more user attributes associated with the business or other named place to which the user's location has been mapped may be added to a user profile associated with the user.

In various embodiments, the user attributes may be associated with the user's location at varying degrees of granularity and/or specificity. For example, the user's profile may be updated based on including information about where the user was in a business or other defined location, say in the International Terminal of an airport as opposed to more generally being at the airport. Such more specific information may signal that the user is not only a traveler but also an international traveler. For another example, the user may be determined to be located in the women's clothing department in a clothes retailer, which may signify that the user is a woman, or say in the appliance section versus the TV section in a big box electronics store to signal someone interested in an appliance rather than a TV.

If the user previously was unknown, a new profile may be created and stored for the user. If the same user is seen again, e.g., a future ad request from the same mobile or other equipment is received, the user's profile may be updated, for example, by adding further attributes about the user to the profile, increasing a confidence level associated with one or more attributes added to the profile previously, etc.

In various embodiments, a “location taxonomy” that assigns demographic and behavior profiles to businesses and places of interests is created and maintained. For example, users in nail salons may be determined based on demographic attributes of past users at that location to be statistically likely to be females, users in plumbing stores may be determined based on demographic attributes of past users at that location to be statistically likely to be males, and users on child playgrounds may be determined based on demographic attributes of past users at that location to be statistically likely to have kids. In various embodiments, attributes ascribed to a user based on attributes associated with places they have visited may be confirmed to be correct or incorrect in a particular case based on other information, for example attributes associated with other locations the same user has visited, user profile information received from and/or confirmed by the user, information from third party data sources about the user, the user's equipment, and/or places the user has been, etc. In some embodiments, rules may be used to classify a zip+4 code as either “home zip” or “work zip,” e.g., based on time of day, proximity to other users, etc. In some embodiments, third party data associating demographic and/or other data with locations at the zip+4 level may be used.

In various embodiments, a user's profile may be determined be associated with a location (e.g., a user's residence, place of work, etc.) based on a user's observed presence at the location. The location may be used to identify third party data (e.g., offline transactional data, survey data, etc.), and the user's profile may be updated to include the third party data. Using this approach a rich user profile may be built based on a combination of a user's location history, third-party data associated with the user, and/or other information.

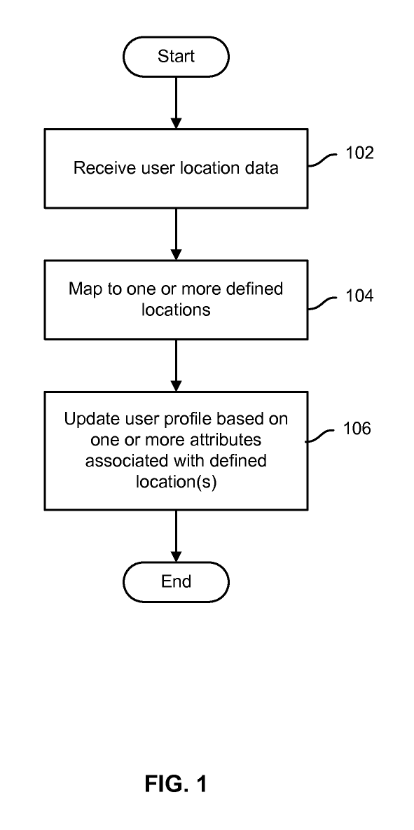

FIG. 1 is a flow chart illustrating embodiments of a process to build a user profile based on information associated with locations with which the user has been associated. In the example shown, user location data is received (102). Examples include, without limitation, receiving an ad request associated with a mobile app user, which includes GPS (e.g., latitude/longitude) and/or other current location data associated with the user. The received location data is mapped to one or more defined locations (104). For example, a received latitude/longitude may be mapped to a business, residential location, and/or other place of interest; a zip+4 or other postal code; a city, neighborhood, or district; etc. A user profile associated with the user and/or the user's equipment (e.g., mobile device) is updated based on one or more attributes associated with the defined location(s) to which the received location has been mapped (106). For example, in some embodiments, when an ad request comes in, backend algorithms and business rules are applied to assign a set of demographic and behavioral attributes to the user. A lookup of the user is performed to see if any prior history on the user has been stored. In some embodiments, an identifier of the mobile device with which an ad request is associated is mapped to a unique identifier associated with a user with which the equipment from which the ad request was received is associated. If no profile exists that is associated with the equipment, a unique identifier is generated and assigned to the previously-unknown user with whom the equipment is presumed to be associated, and the equipment identifier (e.g., mobile identifier) is associated with the user via the profile.

In various embodiments, a user profile may contain user demographic and behavioral attributes derived, for example, from the user's past locations, and may enable a more informed decision to be made as to which ad or other content may be of interest to the user, even if the ad request received from the user's device does not contain location information and/or no useful information is derived from the current location. For example, the user profile lookup may reveal the user is an “auto intender” (i.e., someone currently intending to buy an auto), even though the user is not currently anywhere near an auto dealership.

In some embodiments, a weighted algorithm is used to adjust a current profile on the user based on user information associated with a current location of the user. In various embodiments, over time increasingly accurate profile attributes may be determined, based on information amalgamated about where a user has been.

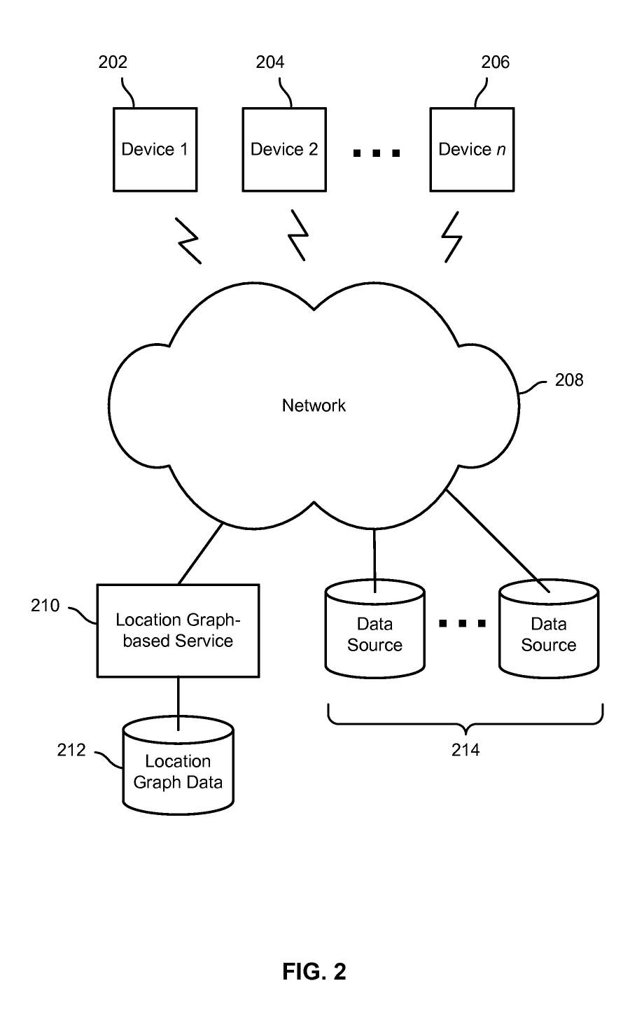

FIG. 2 is a block diagram illustrating embodiments of a system to build a user profile based on location information. In the example shown, users use mobile and/or other devices, represented in FIG. 2 by devices 202, 204, and 206, to communicate via one or more networks, represented in FIG. 2 by network 208, e.g., a mobile telecommunications network, Bluetooth® network, and/or the Internet. A location graph-based service residing on one or more servers 210 receives location information associated with the respective users of devices such as devices 202, 204, and 206. For example, as described above GPS and/or other location information (wifi hotspot id, etc.) may be received in connection with ad requests, e.g., from a mobile app being used by a user and/or a page visited using a browser software on a mobile device. The location graph-based service 210 uses information associated with the current and/or past locations at which the user has been located to determine attributes to be associated with the user, for example by storing such attributes in a user profile for the user. In the example shown, one or more of user profiles; data associating geographic location coordinates, such as latitude and longitude, with a business, residential location, other place of interest, and/or another defined location; and data associating one or more user attributes (e.g., demographic, behavioral, etc.) with respective defined locations are stored in a location graph data store 212. In various embodiments, data from third party and/or other external data sources 214 (e.g., third party data sources) may be used to build and/or update a user's profile based at least in part on the location(s) at which the user has been. For example, third party data sources 214 may be used to map location coordinates to a zip+4 or other postal code and/or to determine for a given postal code one or more attributes to be associated with a user, such as whether the location is a home or work location, and/or demographic data such as median income, etc. In another example, parcel data from a third party data source 214 (e.g., a source of land-related information, county data source, parcel data source) may be used to generate/define a location boundary of a defined location (e.g., residential location, business, place of interest, etc.).

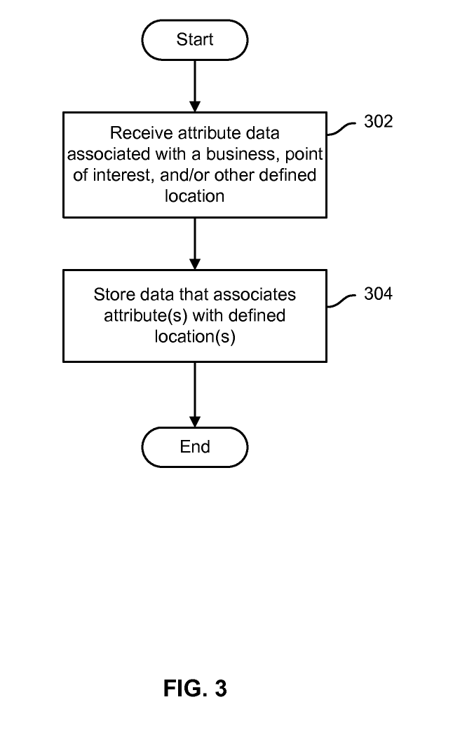

FIG. 3 is a flow chart illustrating embodiments of a process to associate user attributes with defined locations. In the example shown, user attribute data associated with a business, point of interest, and/or other defined location is received (302). Data that associates the user attributes with the defined location is stored (304). For example, if a human operator and/or data from a third party data source indicates a particular business is very much more likely to be patronized by a woman than a man, data associating the gender attribute “female” with the business may be stored. In the case of an activity center for senior citizens, an age attribute of “senior” and/or an employment status attribute of “retired” may be associated with the location. In still another example, an auto dealership may have associated therewith a user attribute reflecting a consumption intention the user may be assumed to be likely to have, such as “auto intender”.

In various embodiments, user attributes may be assigned to places of business based on business floor plans or calendar events. An example of assigning user attributes based on floor plan is if a user is in a big box electronic retailer and by accessing information about the business floor plan, the system is able to determine if the user was in the appliance or TV section as a more specific signal of intent (i.e., to purchase an appliance versus a TV); whether the user was at a sales register as an indication that the user may have responded favorable to an ad sent to the user; or whether the user was at a sales register in the appliance or TV section as a stronger indication that the user actually made a purchase of the type of item advertised. An example of assigning user attributes based on calendar events is a multi-use venue such as an airport or stadium. Stadiums host both sporting events and music events, and in some embodiment a calendar of events is used at least in part to ascribe attributes to users based on the nature of event that is scheduled to be occurring at the time the user is observed to be at the venue

In various embodiments, user attributes may be associated with a defined location with varying degrees of confidence, reflected for example in a confidence or other score and/or weighting associated with the user attribute with respect to that defined location. For example, if 90% of nail salon patrons are known to be female, a gender attribute of “female” may be assigned (at least initially) with a 90% degree of confidence to a user profile of a user observed to be or have been in a nail salon. Other gender attribute information may be or have been derived from other sources, such as based on other locations the same user has visited, and for each such location a corresponding confidence score and/or weighting may be associated with the gender attribute associated with that location. The respective confidence scores, weightings, etc. may be used in various embodiments to determine a most likely value for the attribute and an associated level of confidence, which in various embodiments are stored in the user's profile.

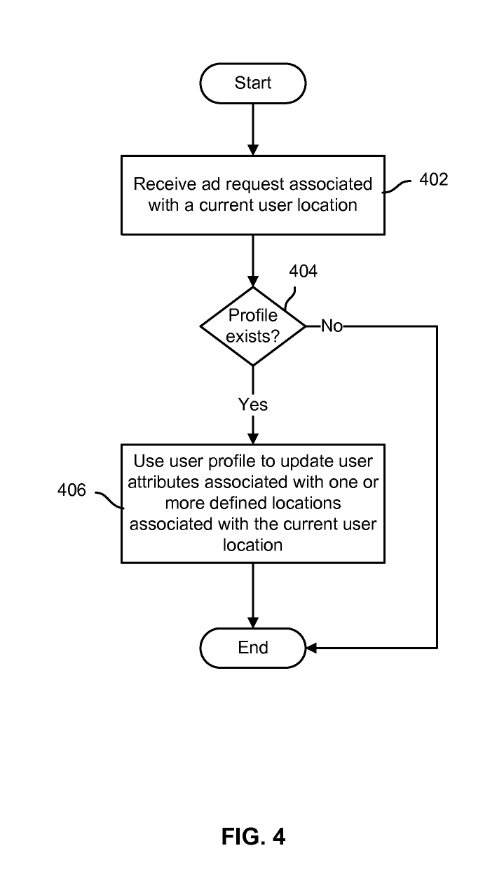

FIG. 4 is a flow chart illustrating embodiments of a process to associate user attributes with defined locations. In the example shown, an ad request associated with a current user location is received (402). If the user has a user profile (404), one or more user attributes of the user, read from the user's profile, may be used to update user attribute data associated with the location (406). For example, if the location is a business, user attributes associated with the user based on the user's past locations and/or other sources may be used to update one or more user attributes associated with the business, and/or to update a confidence score or weighting associated with one or more user attributes. In this way, user attributes of users who visit a defined location may be used, over time, to develop a defined location profile for the defined location and to store therein user attributes observed to be associated with user's who have visited the defined location.

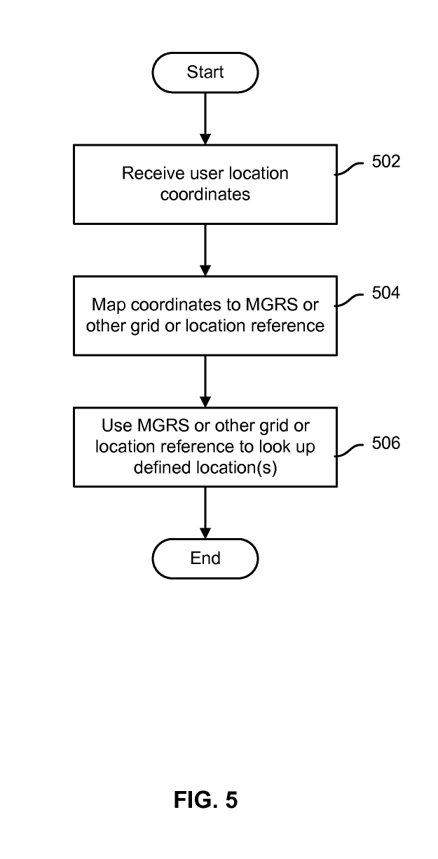

FIG. 5 is a flow chart illustrating embodiments of a process to map current location coordinates to a defined location. In the example shown, user location coordinates, such as latitude and longitude, are received (502). The location coordinates are mapped to a standard and/or proprietary geo-coordinate reference, such as the military grid reference system (MGRS) (504). The MGRS or other grid location to which a set of coordinates has been mapped is used to look up one or more defined locations associated with the determined grid (506). In various embodiments, third party and/or proprietary databases may be used to determine one or more businesses and/or other points of interests that are associated with a given MGRS or other grid or otherwise referenced location.

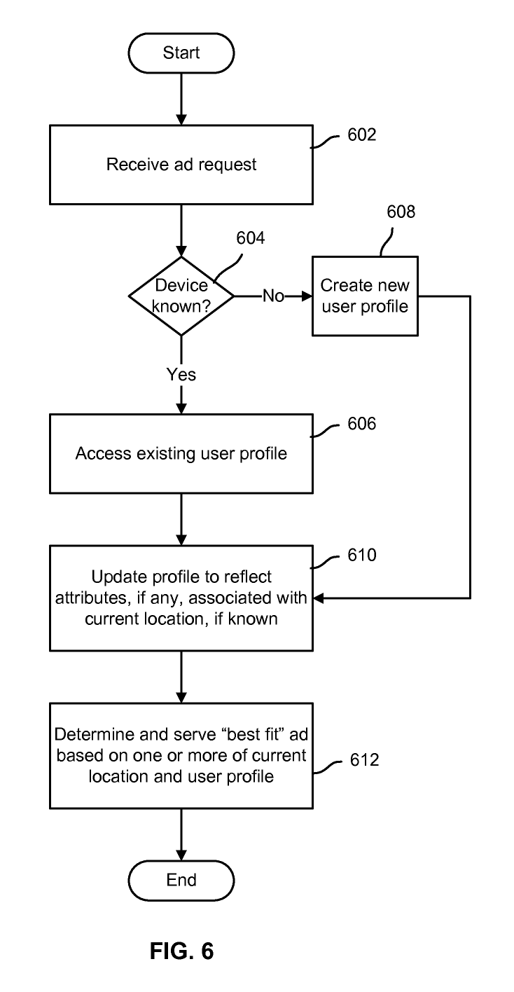

FIG. 6 is a flow chart illustrating embodiments of a process to provide content based on current and/or past location. In the example shown, an ad request that includes location information is received (602). If the device is known (604), an existing user profile is accessed (606); otherwise, a new user profile is created and the device is associated with the newly-created profile (608). The user profile is updated to reflect attributes, if any, associated with the user's current location (610). For example, as noted above, one or more user attributes associated with a defined location to which the user's current and/or past location(s) has/have been mapped may be used to update the user's profile. The update profile and/or the user's current location is/are used, in this example, to determine and serve an ad to the user (612). For example, if the user has visited one or more auto dealerships that day and is currently at a location that has been determined to be the user's home, the user may be served an automobile ad, as a result of having been identified in the user's profile as being an “auto intender” (i.e., a person who currently is at least considering buying an automobile), based on the user's past locations, specifically the automobile dealership(s) the user visited earlier in the day.

In the example shown in FIG. 6, a user's profile and/or current location are used to select and serve an advertisement. In various embodiments, content other than an advertisement may be selected to be provided to the user based on the user's profile and/or attributes associated with and/or derived from the user's current and/or prior locations, including without limitation an article or other non-advertising content; game related content, such as an invitation to download and play a game or an interaction with a game the user has played; an invitation to participate in online social activity, such as by joining a group that has been determined to be of potential interest to the user; an invitation to download an app developed by a retailer, based on the user's affinity towards the retailer or other stores similar to the retailer; a notification of an upcoming event either sponsored or for sale by a retailer based on the user's demographic and behavioral profile, e.g., pre-release concert tickets for music fans or preview only sales for loyal shoppers; etc.

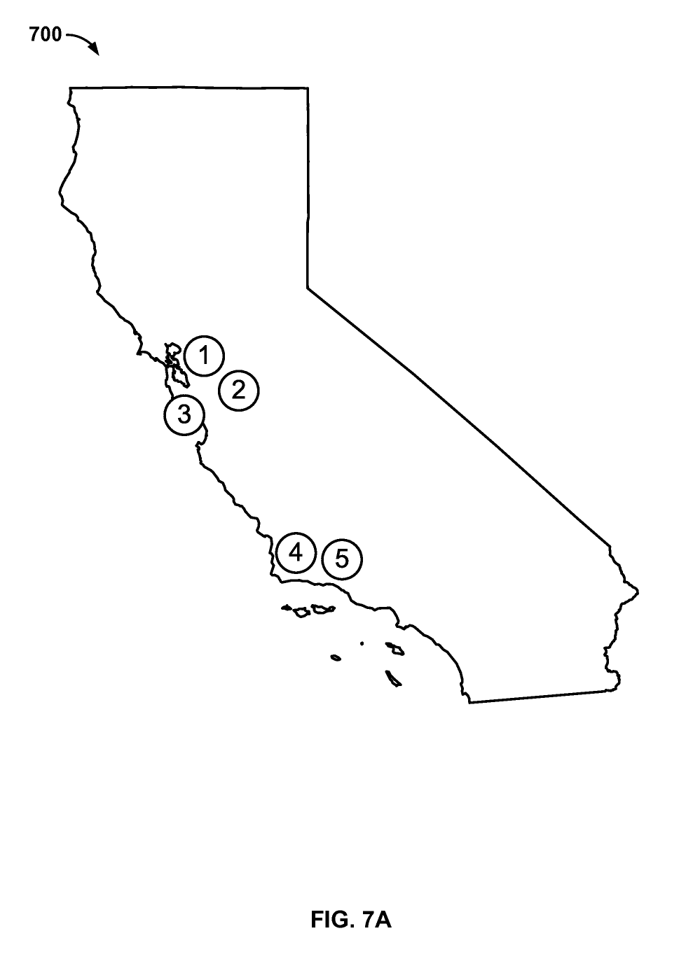

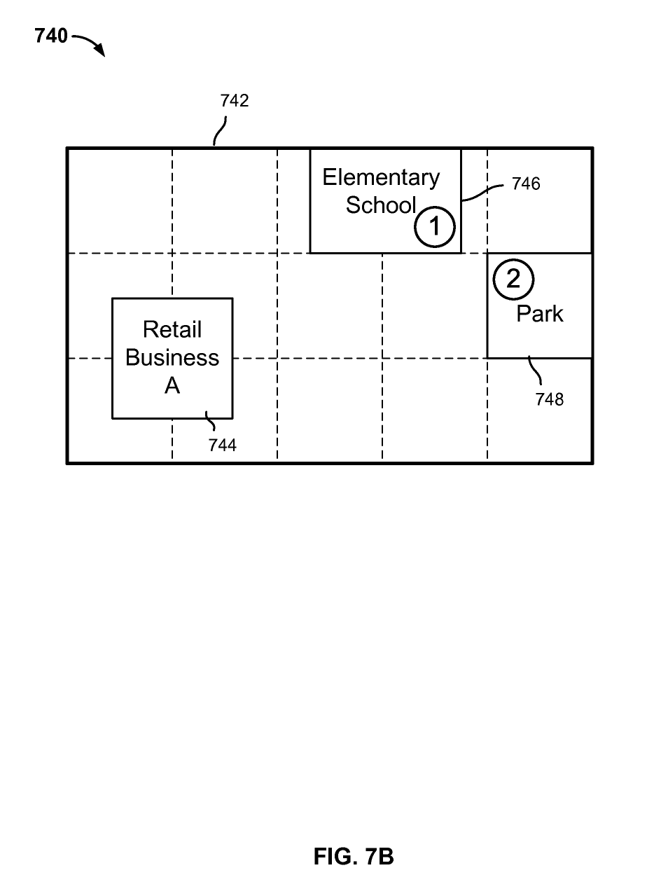

FIG. 7A is a block diagram illustrating embodiments of a location graph. In the example shown, the location graph 700 indicates five numbered locations at which a user has been observed, in this case three locations in the San Francisco Bay Area and two locations in southern California. Depending on the respective times at which the user was at the locations shown in FIG. 7A and the specific nature of and user attributes associated with the respective defined location(s) to which the user's locations were mapped, one or more user attributes of the user may have been derived from the user's presence at the locations shown, and such attributes used to update a user profile of the user. For example, if the locations labeled “3” and “5” were associated with corporate offices of the same company, the user may be determined, possibly tentatively (i.e., with relatively lower confidence) in the first instance, to be associated with that company, e.g., as an employee of and/or service provider to that company. Over time, the degree of confidence may be increased, for example if the user is observed regularly to be at the location “3” during normal working hours Monday-Friday, the user may with higher confidence be determined to be an employee of the company whose primary workplace is in the San Francisco area office. Likewise, if frequent trips outside the user's home area are observed to be made to business-related locations in other cities, the user's profile may be updated to reflect that the user is a (frequent, occasional, etc.) business traveler.

In various embodiments, user attributes may be determined based on one or more prior locations, and those attributes may be used to select an ad to be served in response to ad requests that do not include a location. For example, in some embodiments if enough prior location history is known about a user to assign to the user an “auto intender” profile as described above, the prior location-derived “auto intender” profile may be assigned to the user and used to serve an auto ad even if the current ad request does not have a location.

FIG. 7B is a block diagram illustrating embodiments of a location graph. In the example shown, the location graph 742 shows certain defined locations, in this example a retail business 744, an elementary school 746, and a park 748, each shown in its corresponding location within a grid indicated by dashed lines. In the example shown, depending on the respective times of day, days of the week, pattern in relation to other locations visited, etc., a user who visited the locations “1” and “2” as shown may be determined to be a parent of one or more elementary school age children, for example. User attributes derived from the user's visits to the elementary school and park, in this example, may be used in various embodiments to determine ads to be served to the user. For example, later in the day, when the user is at a home location not shown in FIG. 7B, the user may be served an ad targeted to users who have elementary school aged children. Or, to give another example, the user may be more likely to be served at another location not shown in FIG. 7B an advertisement associated with the retail business 744, based for example on one or more of the user's presence in the past at the illustrated locations relatively near the retail store 744 and one or more user attributes derived from the user's presence in the past at those and/or other locations. For example, if the user in the past has visited an auto dealership associated with an automaker B, the user may be served an ad associated with retail business 744 if, for example, it were a dealership for a competing automobile dealership for the same automaker or a competitive automaker A, based both on a user profile attribute (e.g., “auto intender”) ascribed to the user based on the user's past locations and on the fact that the user has in the past (and possibly regularly) been observed to visit locations in the area in which the retail business 744 is located.

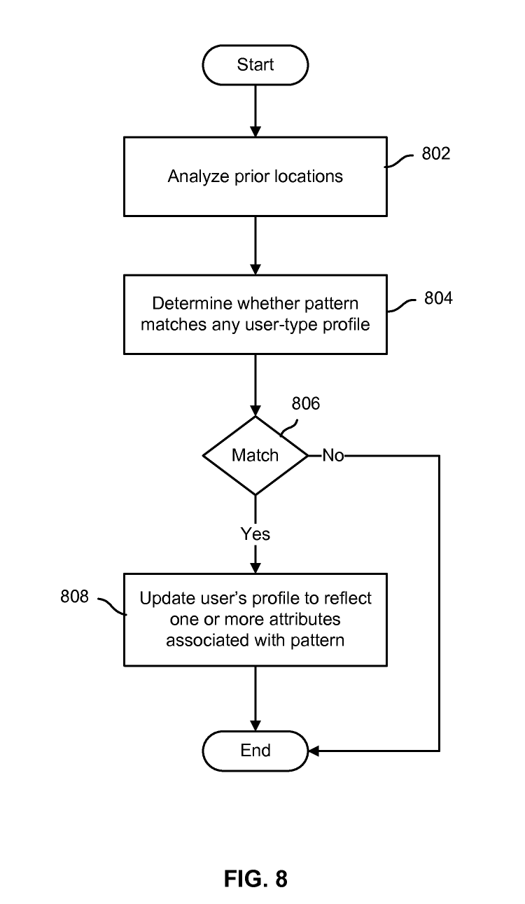

FIG. 8 is a flow chart illustrating embodiments of a process to derive user profile information from past locations. In the example shown, a user's prior locations are analyzed (802) to determine whether the user's location history matches any pattern(s) that may have associated therewith one or more user attributes (804). If the user's location history is determined to match a pattern that has one or more user attributes associated therewith (806), the user's profile may be updated to reflect one or more attributes associated with the matched pattern (808). For example, a user who has been observed to travel regularly on weekday mornings from a home to a nearby school to a grocery store then back to the home and in the afternoon from home to the same school then (sometimes) to a nearby park and then back home may be determined based on those location patterns to be a parent with primary childcare responsibility for a school-aged child. Another user associated with the same home location but who has been observed to travel regularly on weekdays to the same place of business and to remain at that location through most of the work day may be determined to be a member of the same household who is employed outside the home by an employer with which the place of business is associated.

In various embodiments, probabilistic matching approaches may be used to disambiguate between different users in a household (e.g., a parent vs. child, etc.). These probabilistic matching approaches in detail below.

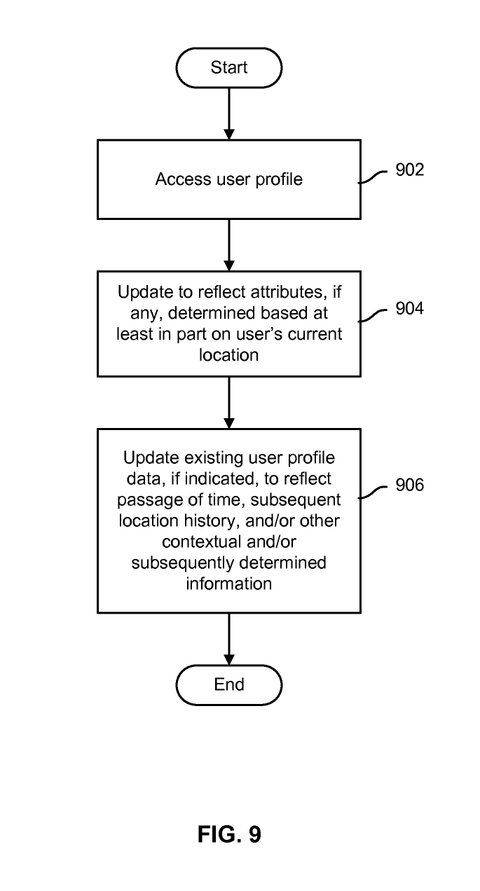

FIG. 9 is a flow chart illustrating embodiments of a process to update a user profile. In the example shown, the user profile is accessed (902). For example, a mobile device identifier associated with a mobile device with respect to which an ad request has been received may be mapped to a unique user identifier, such as a proprietary or other anonymous identifier that is not the same as or based on the device identifier, and an associated user profile accessed. The user profile is updated to reflect user attributes, if any, determined based at least in part on the user's current location (904). For example, a new attribute may be stored, a previously stored attribute may be updated with a new value, and/or a confidence or other score associated with an attribute has stored in the profile may be updated, for example by increasing the confidence level if the user's presence at the current location tends to confirm the correctness of the previously-assigned value, or by decreasing the confidence level if the user's presence at the current location indicates one or more other values may instead be correct. The user's profile data is updated to reflect information other than attributes associated with the user's current location (906), for example to age at least more ephemeral attributes to reflect the passage of time. For example, a user attribute that identifies the user as a female is relatively unlikely to be changed, whereas a designation of a user as an “auto intender” may be removed from a profile after the passage of a sufficient amount of time during which the user is not observed to visit any locations associated with the “auto intender” attribute.

In various embodiments, a mobile advertisement may be served to a user based on third party data that other companies have gathered about the user, including without limitation offline transaction data. In some embodiments, one or more third parties obtain data from retailers about what consumers spend in their stores. Such data typically is referred to as “offline transaction data,” since it happens in a store (and is therefore not “online”) and is transactional because it measures actual purchases. Most third party companies know the user's postal address. In various embodiments, third party data records identified by postal address may be used to map such offline transaction data to user profiles built as described herein. A user's location graph, derived from the user's locations as observed via ad requests and/or otherwise, may be used as described herein to determine and store in the user's profile the user's postal address, an assessor parcel number (APN) associated with user's residence, and/or other identifiers associated with the user's residence. The postal address, APN, and/or other residence-related information determined for the user and stored in the user's profile is then used to “match” data with the third party offline transaction data, enabling both advertisements and measurement studies to be offered to advertisers based on offline transactional data. A measurement study refers in various embodiments to the ability to see how a particular household indexes for a product before and after being exposed to an ad.

In various embodiments, residence-related information (e.g., postal address, APN, etc.) stored in a user's profile may be used to identify/match/integrate any other type of data stored/indexed by a third party. For example, third parties may store many different types of information related to a user (e.g., consumer) by household (e.g., indexed by address, APN, telephone number, etc.). And the information related to a user may be identified based on residence-related information and integrated into the user's profile. In another example, an address included in a user profile may be used to match the user profile data with direct mail providers. Once matched, the direct mail providers may send physical advertising to anonymous residents associated with the address.

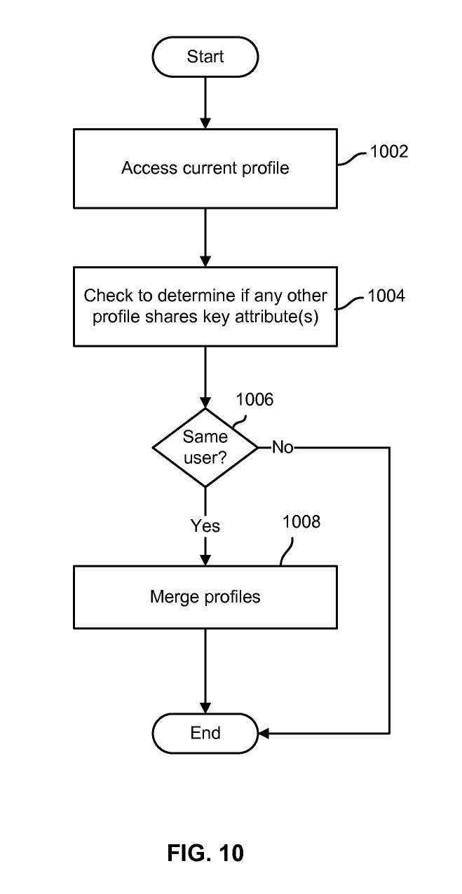

FIG. 10 is a flow chart illustrating embodiments of a process to manage user profile data. In various embodiments, at least initially a unique user may have more than one profile. For example, a user for whom a profile has been built based on the user's use of a first device may acquire and begin using a second device, for example a new phone or other mobile computing device. Initially, the second device will be recognized to be a device that was not previously known. A “new” user profile may be created for an initially anonymous user associated with the second device. Over time, however, the fact that the “user” with which the second device is associated is the same user for whom a profile was created based on the user's use of the first device. In the example shown in FIG. 10, a current profile is accessed (1002), for example in connection with an ad request, or by a process that runs in the background to detect and merge duplicate profiles. A check is performed to determine whether the accessed profile shares any key attribute(s) with any other profile (1004). For example, if the accessed profile has a same home street address as another profile, further processing may be performed to determine whether the profiles are associated with a same user (1006). In some embodiments, the further processing may include checking to determine if other attributes and/or location patterns in the respective profiles are the same or sufficiently similar to conclude that the profiles are associated with a single, same user. If the profiles are determined to be for the same user (1006), the profiles are merged (1008) and the duplicate profile is eliminated. For example, in the example described above, the user profile associated with the first device may be updated to reflect that the same user is also associated with the second device, and any user attribute data stored in the profile created for the second device, such as user attributes derived from locations at which the second device was used, may be used to update the profile associated originally with the first device.

In various embodiments, IP coincidence-based techniques may be used to determine whether two or more devices are associated with a single “user”, and based on such a determination to merge user profiles and/or split a profile into two or more distinct user profiles. Most paid internet subscriptions have a unique IP address. For example, the IP address that powers the WiFi in a user's house is different and unique from the IP address of that user's neighbor, even though both may use the same Internet service provider. For every ad that is served to a user who is connected to the Internet via the WiFi at the user's house, the same IP address is sent in the ad request, regardless of device. So, for example, if the user is using an app on a first device at home over WiFi and later on (could be another day or another week) the user uses an app on a second device at home over WiFi, the two devices would be associated with the same unique IP address. In various embodiments, an IP address to home or other street address mapping is built. The IP address to street address mapping may be used to more correctly assign two devices to one user. For example, in some embodiments, if the street address has been determined to be the user's home address (as opposed to anyplace that has “shared” WiFi, such as work or a public place like a coffee shop or other hotspot), a decision to merge two initially separate profiles, each associated with a separate device identifier but with the same IP address, may be made with higher confidence.

In various embodiments, user profile information derived primarily based on ad requests and associated location information received in connection with a user's use of a first set of one or more devices (e.g., a smartphone) may be used to inform interaction with the same user, via user attribute information stored in the user's profile, during time in which the user is using a typically more stationary and/or location-history rich but at least sometimes mobile or at least portable device, such as a laptop, tablet, or other portable computer. For example, for a typical user who uses a smartphone, a tablet, and a laptop computer, e.g., in the course of a business trip, the user may be observed (for example, via ad requests) to use the tablet and/or laptop at airports, in hotels, and in multiple cities; however, a rich location history may not be able to be built based on the user's use of a tablet and/or laptop alone, because typically a user will not use such a device to connect at restaurants, auto dealerships, beauty salons, etc. By contrast, the user may be observed at a greater diversity of locations through the user's use of their smartphone. By associating all three devices with the same user profile, using techniques disclosed herein, a location-derived profile that more accurately describes the user based on the user's locations as determined (primarily) from their use of their smartphone may be used to target in a more informed way ads sent to the user when the user is using the user's tablet or laptop. For example, if a user was observed based on an ad request received from their smartphone to have been on a car lot this past Sunday, an auto advertisement may be served to the user on the user's tablet while the user is connected to WiFi at home, even though the user never took their tablet to the car lot.

In some embodiments, an ad or other content may be provided in a manner that includes, reflects, and/or is otherwise informed by a user address data stored in the user's profile. For example, in the example described above, the ad for the car lot may be served to the user via the user's tablet while the user is at home in a manner that reflects the system's awareness—based on the user's profile; information included in the ad request, such as the IP address associated with the user's home WiFi; and/or contextual information such as the day of the week, time of day, etc.—that the user is at home or some other user location the street address of which is known. For example, directions from the known user location to a retail store with which an ad is associated may be included and/or a link to such information may be included in the ad.

In various embodiments, a user profile that is based at least in part on a user's location history may be used to select advertising and/or other content to be provided to the user.

While in certain examples described herein a user profile generated at least in part based on a user's past location(s) is used to determine an ad to be served to the user, in various embodiments a profile so generated may be used for one or more other or different purposes, including without limitation to select non-advertising content to be provided to the user. In addition, while in various embodiment a user profile is built to associate with a user one or more attributes derived from that user's past location(s), in other embodiments, advertising and/or other content may be selected for a user based on the user's past location(s) other than by storing in a user profile one or more user attributes derived from such past location(s). For example, in some embodiments, a user's past location(s) may be evaluated dynamically, at content selection time, to select content based at least in part on such past location(s).

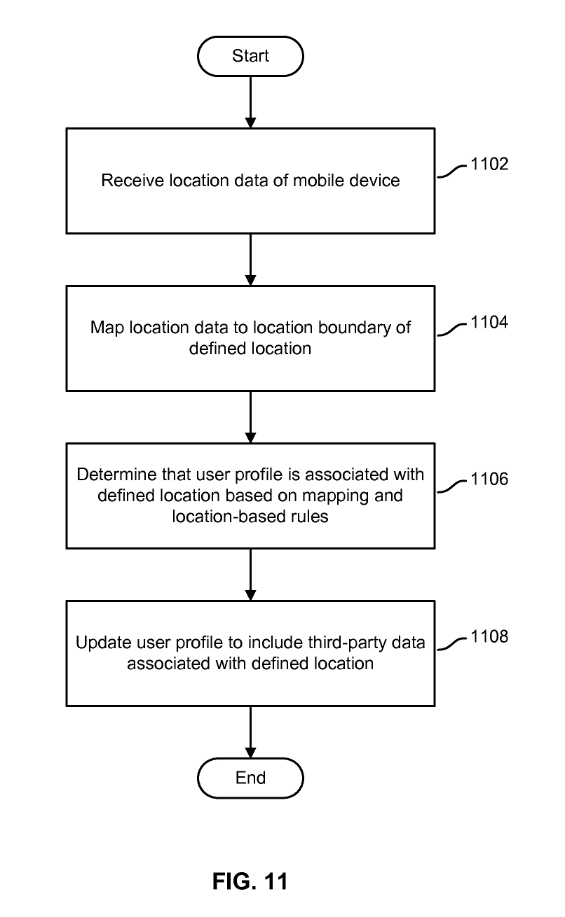

FIG. 11 is a flow chart illustrating embodiments of a process to update user profile data. In the example shown, location data of a mobile device is received (1102). Location data of a mobile device may be received as part of, for example, an ad request, WiFi login, and/or other actions associated with a mobile device. Location data of a mobile device may include coordinates (e.g., GPS coordinates, latitude and/or longitude) and/or other location data associated with the mobile device. For example, the location data (e.g., coordinates) may include coordinates in a geo-coordinate reference system (e.g., MGRS, UTM, geographic information system (GIS)-based coordinates, etc.).

In various embodiments, location data of a mobile device may be mapped (1104) to a location boundary of a defined location. In various embodiments, a defined location may include a residential location (e.g., residential address), a business, location of interest, and/or other type of location. A defined location may be identified by, for example, a postal address (e.g., street address), telephone number, assessor parcel number (APN) (e.g., 001-002-03), parcel identification number (PIN), parcel identifier, and/or other identifier. The defined location may include a location boundary. The location boundary may include a digital representation of the borders, edges, and/or contours of the defined location (e.g., a piece of property). The location boundary may include, for example, a geo-fence, an area defined/bounded by location coordinate(s), a polygon/circle defined by location coordinate(s), geometric shape, and/or other information. The location boundary may, for example, define and/or include a digital representation of the metes and bounds of a defined location (e.g., residential location). In various embodiments, the location boundary may be defined by parcel data received/retrieved from a parcel data source.

In various embodiments, location data of the mobile device may be mapped to a defined location (e.g., a household) by determining whether the location data includes a grid location that lies (e.g., is located) within the location boundary of a defined location. In the event the location data is determined to be within a location boundary of a defined location, the location data of the mobile device may be mapped to the location boundary.

According to various embodiments, it may be determined (1106) that a user profile is associated with the defined location based on the mapping of mobile device location data to the defined location and/or the application of one or more location-based rules. In various embodiments, a user profile may be associated with a mobile device and/or a user. Based on the mapping of the mobile device location data to the location boundary of the defined location, it may be determined that a user profile associated with the mobile device is associated (e.g., likely/possibly associated) with the defined location. When, for example, a mobile device is observed within a location boundary associated with a residence, it may be determined that a user who owns the mobile device is associated with the residential location (e.g., the user is possibly a member of a household residing at the residential location).

In various embodiments, location-based rules may be applied to determine (e.g., confirm) whether the user profile is associated with the defined location. Location-based rules may include, for example, rules based on time(s) of presence at a location (e.g., temporal rules/policies), frequency of presence at a location, a context associated with user's presence at a location, user attribute data, location attribute data, and/or other information. In one example, a location-based rule may specify that a user present at a residential location more than three times per week (e.g., on three separate days) is likely a member of the household associated with the residential location. Applying this location-based rule, a user (e.g., a user's mobile device) who is observed at the residential location six times per week may be determined to be associated with the residential location.

In some embodiments, the user profile may be updated (1108) to include third-party data associated with the defined location. In various embodiments, third-party data may include offline transaction data (e.g., data associated with purchases/transactions made in a store), survey data, and/or other types of data. Third-party data may, for example, be gathered by retailers, credit card companies, advertisers, survey data collectors, and/or other entities. In one example, third-party data may include offline transactional data reflecting a user's purchases/transactions at a physical (e.g., brick and mortar) retail location. In another example, third-party data may include survey data provided by a user regarding a wide variety of topics. In some embodiments, third-party data may be indexed by an identifier such as postal address, telephone number, and/or other identifier associated with a user. And these identifiers may be associated with a defined location (e.g., household, business, and/or location) with which the user is associated.

In various embodiments, a defined location (e.g., a residential location) may include a nexus, link, bridging point, and/or common data point used to combine user attribute data included in a user profile with third-party data (e.g., offline transactional data, survey data, direct-mail provider data, etc.). For example, third-parties may collect and/or store a wide variety of data on users, and this data is often indexed/stored by household (e.g., at the household level). And based on a determination that a user profile is associated with a defined location, it may be determined (e.g., with a degree of confidence) that the user associated with the user profile is a member of the household at the defined location. And an identifier (e.g., postal address, household, etc.) associated with the household may be used to identify/select third-party data. The defined location identifier may be used to match a user's profile with third-party data associated with the user. In various embodiments, the third-party data may be added to the user profile. In some embodiments, the techniques disclosed herein may be used to match with direct mail providers to provide advertising materials to anonymous residents of an address.

In various embodiments, one or more of steps 1102-1108 may be performed iteratively, recursively, and/or repeatedly. For example, location data may be received from a mobile device at multiple times (e.g., over a period of time). Location data for a mobile device may be repeatedly mapped to location boundaries (e.g., as the location data is received over time), and, in some embodiments, a mapping of the location data to a location boundary of a defined location may include a mapping of multiple mobile device location data points over a period of time. Location-based rules may be applied based on multiple mappings of location data to a defined location as discussed herein.

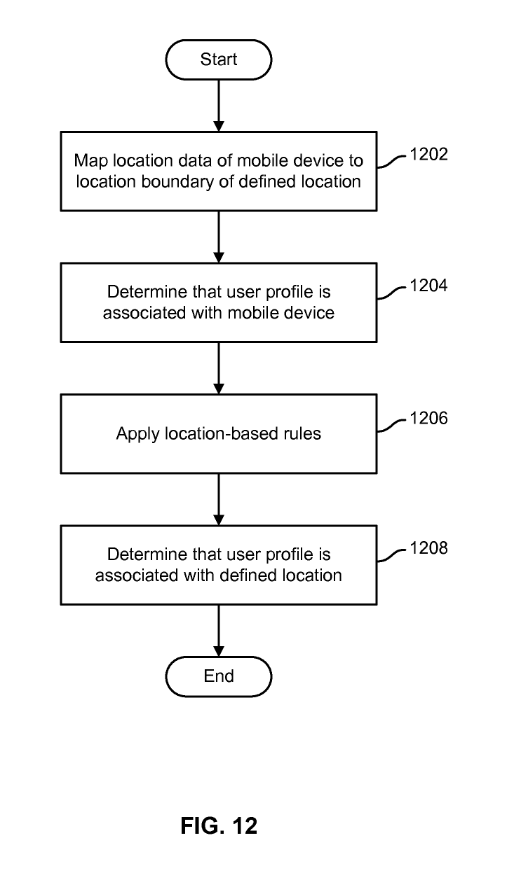

FIG. 12 is a flow chart illustrating embodiments of a process of determining an association between a user profile and a location. In the example shown, location data is mapped (1202) to a location boundary of a defined location. As discussed above, the location data of a mobile device (e.g., received in an advertising request, Wi-Fi login, etc.) may be mapped to coordinate(s) in a geo-coordinate reference system, and it may be determined whether the coordinate(s) are included within an area defined by the location boundary of the defined location (e.g., a residential location). The location boundary may be defined by, for example, parcel data and/or other property-related data as discussed below.

In various embodiments, it may be determined (1204) that a user profile is associated with the mobile device. For example, an identifier of the mobile device (e.g., mobile device ID, unique device ID (UDID), etc.) with which an ad request is associated may be mapped to a unique identifier associated with a user. And the identifier associated with the user may be used to select/identify a user profile associated with that user.

According to some embodiments, location-based rules may be applied (1206). Location-based rules may be applied to determine whether the user profile is (e.g., should be) associated with the defined location. Location-based rules may include, for example, rules based on time(s) of presence at a location (e.g., temporal policies), frequency of presence at a location, user attribute data, location attribute data, and/or other information. In various embodiments, location-based rules may be applied based on a context of a mapping of location data to a defined location. For example, a context of mapping of location data to a defined location may include a time, frequency, duration, temporal patterns, and/or other attributes associated with the mapping of location data to a location boundary associated with a defined location. In one example, a location-based rule may specify that users observed to be regularly present (e.g., more than three times per week) at a residential location during a period of time from 6 PM to 8 AM are likely associated with the residential location. Applying this location-based rule, a user (e.g., a user's mobile device) who is regularly observed at the residential location during the period from 7:30 PM to 7:00 AM may be determined to be associated with the residential location. Based on the application of the location-based rules, evaluation of user attributes, and/or evaluation of other information, the user may be determined to be a member of the household at the residential location. On the other hand, another user observed at the residential location two times per month from 12 PM to 2 PM may be determined to be not associated with residential location. This user may, for example, include a music instructor, maintenance worker, etc.

In various embodiments, location-based rules may also be used to categorize one or more users determined to be associated with a defined location. For example, location-based rules may be used to categorize different members of a household. In one example, a first user who is repeatedly observed at a house during a period from 7 PM to 7 AM but is rarely observed at the house during the day on weekdays may be categorized as a member of the household that is employed outside of the home (e.g., a parent). In another application of location-based rules, a second user who is regularly observed to be at the household during the day on weekdays may be determined to be a parent with primary childcare responsibilities who is also a member of the household. In a further example, a third user may be identified as a child who is a member of the household based on, for example, the application of location-based rules to the third user's location patterns and/or user attribute data.

In some embodiments, it may be determined (1208) that the user profile is associated with the defined location. Based, for example, on a mapping of the mobile device location data to the location boundary, a determination that the mobile device is associated with the user profile, and/or the application of location-based rules, it may be determined that the user profile is associated with the defined location. For example, a determination that a mobile device is at a location within a location boundary associated with a defined location may indicate that a user associated with the mobile device is possibly associated with the defined location. Based on the application of location-based rules, a user may be determined (e.g., with a certain level of confidence) to be associated with the defined location. For example, a user's frequency of presence within a location boundary associated with a residential location may satisfy one or more location-based rules, and the user may be determined to be a member of the household residing at the residential location.

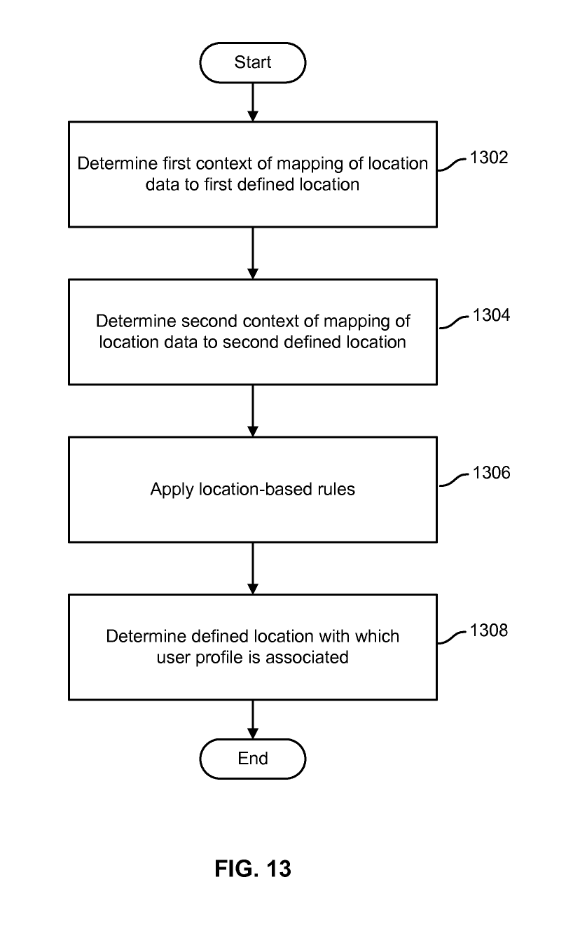

FIG. 13 is a flow chart illustrating embodiments of a process of determining an association between a user profile and a location. In various embodiments, location data associated with a mobile device and/or a user profile may be mapped to a first defined location (e.g., a first household), a second defined location (e.g., a second household), and/or other defined locations. In the example shown, a first context associated with the mapping of location data to the first defined location may be determined (1302). For example, location data for a mobile device may be mapped to a first location boundary associated with a first defined location (e.g., a first household) based on observation of the mobile device within the first location boundary over a certain period of time (e.g., at different times on six separate consecutive nights). In this case, the presence of the mobile device at the first location at different times on six separate consecutive nights may include a context of the mapping of the location data to the first defined location.

In various embodiments, a second context associated with the mapping of location data to the second defined location may be determined (1304). For example, location data associated with the same user profile and/or mobile device may be mapped to a second location boundary associated with a second defined location (e.g., a second household) based on observation of the mobile device within the second location boundary over a certain period of time (e.g., 10 AM to 2 PM on Jan. 1, 2014). In this case, the presence of the mobile device at the second location from 10 AM to 2 PM on Jan. 1, 2014 may include a second context of the mapping of the location data to the second defined location.

In various embodiments, location-based rules may be applied (1306). In various embodiments, location-based rules may be applied to determine which defined location (e.g., household) the user profile is associated. In one example, location-based rules may specify that a user observed at a residential location more than four nights per week presumptively (e.g., barring other countervailing evidence) resides at the residential location. Applying the example location-based rules, it may be determined that the user profile is more likely associated with first defined location (e.g., first residential location) than the second location by virtue of, for example, the user's observed presence at the first residential location on six consecutive nights. It may be determined (1308) which defined location a user profile is associated. In this example, based on the application of the location-based rules, it may be determined that a user profile associated with the mobile device is associated with the first defined location.

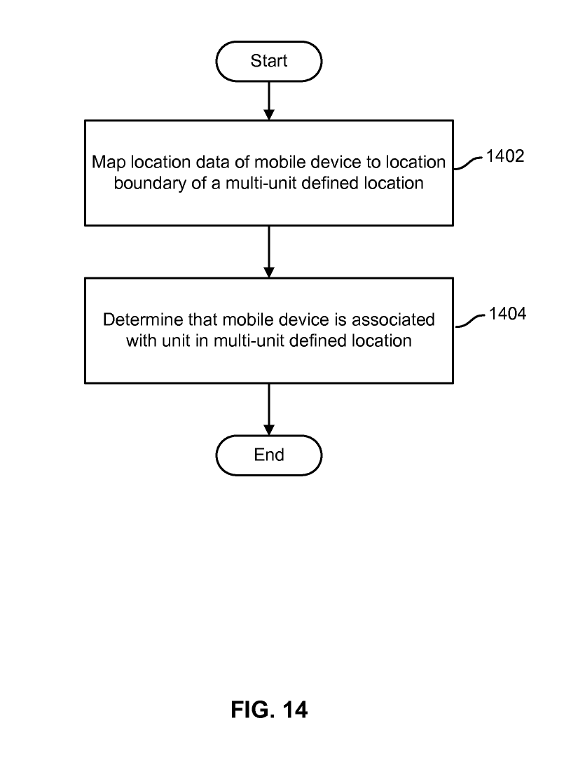

FIG. 14 is a flow chart illustrating embodiments of a process of determining an association between a user profile and a unit in a multi-unit defined location. In the example shown, location data is mapped (1402) to a location boundary of a defined location including multiple units (e.g., a multi-dwelling unit location, multi-family residential location, apartment building, condo, office building including multiple units, etc.). As discussed above, the location data of a mobile device may be mapped to coordinate(s) in a geo-coordinate reference system, and it may be determined whether the coordinate(s) are included within an area defined by the location boundary of the multi-unit defined location.

According to some embodiments, it may be determined (1404) that the mobile device is associated with a unit in the multi-unit defined location. A mobile device may, for example, be matched to a unit in the multi-unit defined location. In one example, internet protocol (IP) addresses, wireless networks (e.g., Wi-Fi networks, Bluetooth® networks, etc.), and/or other network information associated with units in a multi-unit location may be used to determine an association (e.g., match) between a mobile device and a unit. In some cases, each unit in a multi-unit location may be associated with IP address(es) (e.g., an IP address assigned to the unit by an internet service provider (ISP)), Wi-Fi network(s), Bluetooth® network(s), and/or other network information. And the network information may be used to distinguish between multiple units in a multi-unit location. For example, it may be determined that a mobile device is associated with a certain IP address by virtue of the fact that the mobile device has been observed transmitting and/or receiving data via the IP address. Based on this determined association between the mobile device and an IP address associated with a unit, the mobile device may be matched to the unit (e.g., determined to be associated with the unit). In another example, a mobile device may be observed transmitting and/or receiving data over an 802.11 connection (e.g., Wi-Fi connection, wireless local area network (WLAN), etc.) associated with a unit. The mobile device may, for example, be logged in to Wi-Fi network associated with a unit after completion of a credential verification process (e.g., password entry), and observation of the mobile device communicating via the Wi-Fi network may indicate that the device is associated with the unit. Similar approaches may be used based on Bluetooth®, near field communication (NFC), and/or other network information known to be associated with a unit in a multi-unit defined location.

In some embodiments, a mobile device may be matched to a unit in the multi-unit defined location using other approaches. For example, a mobile device may be mapped to a multi-unit defined location, and it may not be possible to determine an association between the mobile device and an IP address, Wi-Fi network, Bluetooth® network, and/or other network information associated with any of the units. In this case, other factors may be used to determine an association between the mobile device and a particular unit. In one example, an association between a mobile device and a unit may be determined based on known associations between other mobile devices and units in the building. By way of example, in a two-unit building an association between a first mobile device and a first unit may be determined using the network-based approaches discussed herein. A second mobile device may be mapped to the two-unit building, but an association between the second mobile device and the first unit may not be established using the network-based approaches. In certain cases, it may be presumed/determined (e.g., provisionally presumed) that the second mobile device is associated with the second unit in the two-unit building. This presumption may be reinforced and/or rebutted by other factors. For example, if the first mobile device associated with first unit is no longer observed at the location after a certain point in time, while the second mobile device continues to be observed at the location, it may be presumed that the user associated with the first mobile device moved out while the tenancy/ownership of the second unit remains unchanged. And the presumption/determination that the second mobile device is associated with the second unit may be strengthened. In other words, a confidence of association between the second mobile device and the second unit may be increased. This is one example approach for determining an association between a mobile device and a unit in multi-unit defined location. Additional approaches (e.g., statistical approaches, empirical approaches, process of elimination, etc.) may of course be used.

In some embodiments, matching a mobile device to a unit in a multi-unit defined location may include applying location-based rules. For example, the location-based rules may include rules that if a mobile device is active on Wi-Fi network of a unit more than a certain amount of times, the mobile device may be determined to be associated with the unit. In another example, the other approaches discussed herein may be applied as location-based rules.

In various embodiments, a user profile may be matched to the unit(s) using the approaches discussed herein and/or known in the art. For example, based on the determined association between a mobile device and a unit in a multi-unit defined location, it may be determined that a user profile associated with the mobile device is associated with the unit in the multi-unit defined location.

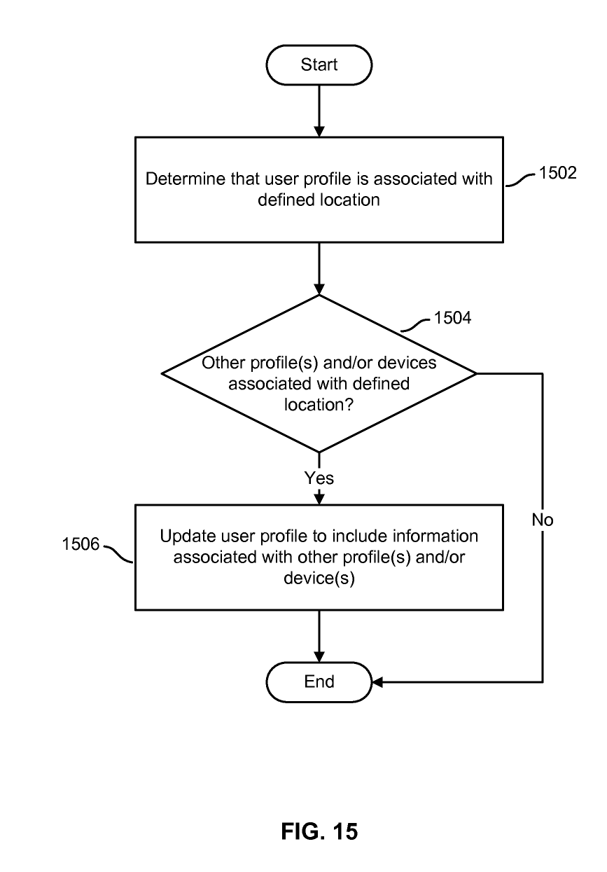

FIG. 15 is a flow chart illustrating embodiments of a process of deterministically matching devices and/or profiles. In the example shown, it may be determined (1502) that a user profile is associated with a defined location. In various embodiments, based on a mapping of the mobile device location data to a location boundary, a determination that the mobile device is associated with the user profile, and/or the application of location-based rules; it may be determined that the user profile is associated with the defined location.

It may be determined (1504) whether other profiles and/or devices are associated with the defined location. In some embodiments, it may be determined whether other user profiles are associated with the defined location. The other user profiles may include, for example, a user profile including information associated with desktop computers, laptop computers, other mobile devices, wearable devices, smart appliances, and/or other types of devices. For example, the other user profile(s) may include information associated with devices (e.g., laptop, desktops, mobile devices, etc.) that have cookies (e.g., browser cookies) associated with them. In various embodiments, the other user profile(s) may be generated by and/or otherwise associated with a third party (e.g., an entity/enterprise/company separate from the party that generated the user profile discussed in step 1502). In some embodiments, it may be determined that another user profile associated with cookie-based devices is associated with the defined location. This determination may be based, for example, on an association between the other user profile and a postal address (e.g., street address), telephone number, assessor parcel number (APN) (e.g., 001-002-03), parcel identification number (PIN), parcel identifier, and/or other identifier. For example, the other user profile may include a postal address associated with the defined location (e.g., list a postal address user), and this postal address may be used to determine that the other user profile is also associated with the defined location (e.g., match the other profile to the defined location).

In another example, a multiple service operator (MSO) may generate a profile including media access control (MAC) address information for mobile device(s) determined to be associated with a defined location. The MAC address information for a mobile device may include, for example, a MAC address associated with components included in a mobile device (e.g., Wi-Fi radio components of a mobile device). An MSO-associated profile may also include information identifying a defined location (e.g., household postal address, etc.) and/or other information. And the information identifying a defined location may be used to determine that the MSO profile is associated with the defined location (e.g., a household).

In various embodiments, it may be determined whether other devices (e.g., devices separate from the device(s) included in the user profile of step 1502) are associated with the defined location. The other devices may include, for example, desktop computers, laptop computers, other mobile devices, wearable devices, smart appliances, networking hardware, and/or any other type of devices. For example, it may be determined whether cookie-based devices (e.g., laptops, desktops, mobile web browsers, etc.) are associated with the defined location. In one example, it may be determined that a cookie-based device (e.g., a laptop computer) is associated with the defined location based, for example, on a determined association between the IP address, Wi-Fi network, Bluetooth® network, and/or other network associated with the defined location.

In the event that other profile(s) and/or device(s) are determined to be associated with the location, the process may proceed to step 1506. In the event that other profile(s) and/or device(s) are not associated with the location, the process may end.

The user profile may be updated (1506) to include information associated with other profile(s) and/or device(s). In some embodiments, the user profile determined to be associated with the location (e.g., as discussed in step 1502) may be updated to include information from other profiles (e.g., user profiles associated with a third party) that are also determined to be associated with the defined location (e.g., in step 1504). For example, data generated by a third party (e.g., an entity separate from the entity that generated the user profile of step 1502) may be added to the user profile.

In one example, an MSO-associated profile (e.g., a profile generated by an MSO) including, for example, MAC address information for mobile devices associated with the defined location may be added to the user profile. Upon addition of the MSO-associated profile, a MAC address associated with a mobile device may be matched to application device identifiers (e.g., app device IDs) included in the user profile.

In various embodiments, a user profile associated with the defined location may be updated to include information associated with other device(s) also determined to be associated with the defined location. For example, based on a determination that a device is associated with a defined location (e.g., in step 1504), a user profile associated with the location may be updated to include information associated with the device. In one example, upon a determination that network hardware (e.g., a WiFi component) is associated with the defined location, an identifier (e.g., MAC address) associated with the networking hardware may be added to the user profile. In this way, a user profile previously determined to be associated with a location (e.g., based on a mapping of mobile device associated with the profile to the defined location) may be updated to include information associated with any other devices (e.g., laptops, desktops, networking hardware, etc.) also determined to be associated with the location.

According to some embodiments, a user profile may be generated that includes information associated with a user's mobile device(s), laptop computer(s), desktop computer(s), mobile device browser(s), wearable device(s), smart appliance(s), networking hardware, and/or other any other devices. Using the defined location (e.g., a household) as a nexus, multiple user profiles and/or devices may be deterministically matched with (e.g., added to) a user profile (e.g., a user). As a result, the user profile may provide a rich dataset of information about a user and/or device. And this dataset may be used to bridge (e.g., draw correlations between) any combination of user attributes, mobile device IDs, mobile device MAC addresses, networking hardware identifiers (e.g., networking hardware MAC addresses), cookie-based device information, and/or any other information included in the user profile. In one example, this dataset may be used by an MSO to correlate a MAC address determined by the MSO to be associated with a mobile device with a mobile device application identifier included in the user profile. This correlation may be used to bridge mobile device MAC address information and application device IDs (e.g., associated with the same mobile device). By bridging this information, a rich dataset of information about a mobile device and/or user may be generated that includes data from a variety of sources including, for example, location-based attribute data, MSO-generated data, other third party data, and/or data from other sources.

In various embodiments, probabilistic matching approaches (e.g., fuzzy matching) may be used to disambiguate different users within a household. Probabilistic matching may be used to disambiguate (e.g., categorize) users, profiles, and/or devices determined to be associated with a defined location. In one example, probabilistic matching approaches may be used to assign user profiles and/or devices to specific user(s) within a group of users determined to be associated with a defined location. Probabilistic matching may, for example, be used to categorize a first user profile determined to be associated with a location as a parent profile and second user profile as child profile.

According to some embodiments, location patterns included in a user profile may be probabilistically matched to predefined patterns each associated with user attribute(s). Predefined patterns may include, for example, patterns generated for user attribute determination, patterns associated with existing user profiles, and/or any other types of patterns. A location pattern in a user profile may, for example, be compared to multiple predefined patterns (e.g., location patterns) using a probabilistic matching approach, and matching (e.g., closest matching) predefined pattern(s) may be determined. For example, data (e.g., data points, locations, times, frequencies, and/or other data) in a user profile may be matched to data (e.g., data points, locations, times, frequencies, and/or other data) in one or more predefined patterns. Weights may be assigned to each of the matching data values (e.g., data points) based, for example, on how well the data in the user profile matches data in the predefined location pattern. A likelihood of match between a location pattern and a predefined location pattern may be generated based on the weighted matching data values. In certain cases, a predefined location pattern may be determined to match a location pattern in the user profile based on the likelihood (e.g., probability) of a match. In some embodiments, a location pattern in a user profile may compared to multiple predefined patterns and one or more closest matching predefined patterns may be determined. Predefined location patterns may be associated with attributes (e.g., a child, adolescent, parent with primary childcare responsibilities, working professional, etc.), and these attributes may be used to disambiguate (e.g., delineate) the user profile from other user profiles associated with the defined location (e.g., household). The attributes may be used to determine, for example, that the user profile is associated with a member (e.g., a specific member) of a household (e.g., a child, a parent, etc.). In some embodiments, attributes (e.g., indicating parent with primary childcare responsibilities, child, etc.) associated with the matching (e.g., closest matching) predefined patterns may be added to the user profile.

In various embodiments, IP address patterns in a user profile may be matched to predefined patterns using a probabilistic matching approach. In one example, IP address access patterns (e.g., including times, durations, locations, and/or other information associated with IP address access) included in a user profile may be probabilistically matched to predefined access patterns (e.g., IP access patterns). And attributes (e.g., parent, child, etc.) associated with a predefined access patterns determined to match the user profile may be added to the user profile.

Using the approaches discussed herein in various embodiments, multiple profile data sets (e.g., mobile device location-based profile data, third-party profile data (e.g., cookie-based data, MSO-associated data), etc.) and/or multiple devices (e.g., mobile device(s), laptops, desktops, networking hardware, etc.) may be deterministically matched to a defined location. For example, data from multiple sources (e.g., user profiles, third party data sources, etc.) may be joined at the household level in one or more user profiles associated with the household. In various embodiments, each of one or more user profiles associated with a defined location may then be matched to one or more individuals associated with a defined location using the location pattern-based probabilistic matching approaches discussed herein. Based on this probabilistic matching, correlations may be drawn between an individual user (e.g., within a household) and any combination of user attributes, mobile device IDs, mobile device MAC addresses, networking hardware identifiers, cookie-based device information, and/or any other information included in the user profile.

In various embodiments, the user profile data resulting from the deterministic and/or probabilistic matching approaches discussed herein may be provided to a third party. For example, the user profile data may be provided to a third party (e.g., a third party that generated data included in (e.g., added to) the profile), an MSO, an advertising content provider, a direct mail advertiser, a Customer Relationship Management (CRM) provider, a Data Management Platform (DMP) provider, a Business Intelligence provider, and/or any other entity.

According to some embodiments, the user profile data resulting from the deterministic and/or probabilistic matching approaches discussed herein may be used to generate and/or provide advertisements to the devices included in the user profile. For example, advertisements may be targeted to mobile device(s), cookie-based devices (e.g., laptops, desktops, mobile web browsers, etc.), wearable devices, smart appliances, and/or any other devices deterministically and/or probabilistically matched to the defined location. In certain cases, advertisements that would otherwise only be targeted to devices in a location-based profile may be deployed to newly-linked device(s). The newly-linked devices may include devices matched (e.g., deterministically matched) to the user profile based on data from third party sources. In some embodiments, the advertisements targeted to devices identified in the profile may be generated based on user attribute and/or other information in the profile. As a result, the ads may be specifically tailored to be of interest to the user associated with the devices.

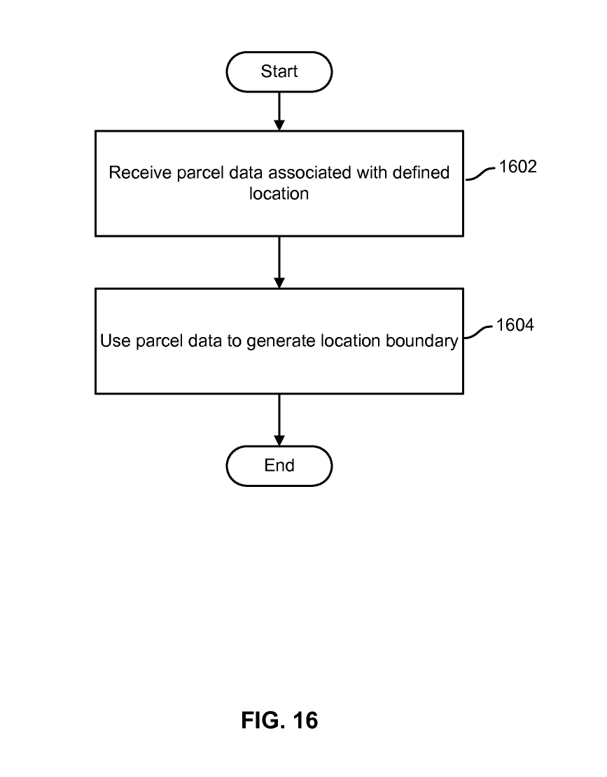

FIG. 16 is a flow chart illustrating embodiments of a process of generating location boundary data. In the example shown, parcel data associated with a defined location may be retrieved and/or received (1602). Parcel data may be received from, for example, a property records database, county records database, commercial database, and/or any other source. In various embodiments, the parcel data may be used to generate (1604) a location boundary. Parcel data may, for example, define the metes and bounds of a piece of property, may define the contours of a boundary surrounding a property (e.g., a residential location), may delineate a parcel of land from surrounding land/property, and/or include other descriptive features associated with a parcel of land. For example, parcel data may include vectors, points, lines, polylines, polygons, arcs, GPS coordinates, MGRS coordinates, geographic information system (GIS) coordinates, and/or other geometry used to define the boundaries of a location (e.g., residential location, property, etc.). Parcel data may be indexed by identifiers including, for example, postal addresses, phone numbers, APNs, PINs, and/or other parcel identifying information. Upon ingestion, the parcel data may be parsed to identify addresses, APNs, PINs, and/or other parcel identifying information associated with each of multiple parcels. And parcel data defining the boundaries of one or more defined locations may be stored in a database of location boundary data (e.g., location database 212 of FIG. 2). For example, an address may be stored along with parcel data defining a location boundary (e.g., a polygon surrounding the location) of a piece of property at the address.

Deriving location boundaries from parcel data using the approaches disclosed herein in various embodiments results in the generation of highly accurate and/or precise of the location boundary data for defined location (e.g., residential location(s)). Using this location boundary data in the context of the approaches disclosed herein, it is possible to determine with a high level of granularity whether a user is present at defined location (e.g., in a yard associated with the defined location) or close to the location (e.g., on the street in front of the defined location).

In various embodiments, parcel data may be used to determine a type, designation, and/or classification of a location. For example, parcel data may include information indicating whether a property is residential, commercial, government land, public property, and/or other type of property. In various embodiments, designations/classification associated with a defined location may be used as filter. In one example, for the purpose of identifying a user's residence, location data of a mobile device may only be mapped to residential locations and other types of locations may be filtered out. In this case, if a user is observed at a location designated public land (e.g., a park), this location data may, for example, not be used.

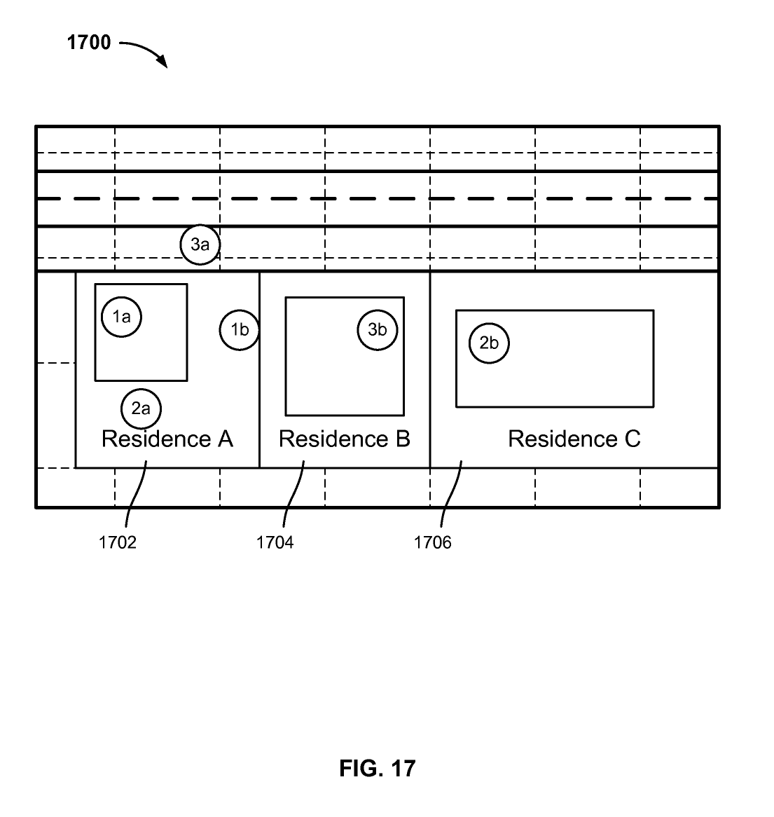

FIG. 17 is a block diagram illustrating embodiments of a location graph. In the example shown, the location graph 1700 shows certain defined locations including a residence A 1702, residence B 1704, and residence C 1706, each shown in its corresponding location within a grid indicated by dashed lines. In the example shown, depending on the respective times of day, days of week, frequencies, patterns, and/or other factors in relation to locations visited, a user may be determined to be associated with the various households illustrated in the location graph 1700. For example, a first user may be observed at 9 PM at night on a weekday at location “1a,” inside of residence A 1702. The first user may also be observed at location “1b,” near a boundary of residence A, at 3 PM on a weekend day. In various embodiments, location boundaries associated with residence A 1702 may have been generated based on parcel data retrieved from, for example, a government land database. And the location boundaries generated using the approaches disclosed herein may, therefore, be an accurate and/or precise representation of the contours of defined location. And based on the accuracy and/or precision of the defined location boundary data it may be determined that the first user is in the yard near the boundary of residence A 1702 rather than within the location boundary of residence B 1704. Based on the first user's presence within the location boundary of residence A 1702 at 9 PM on a weeknight and 3 PM on weekend day, it may be determined that the first user is a member of the residence A 1702 household.

In various embodiments, a user may be observed at a location in the context of multiple mobile devices. For example, the first user may be observed at location “1a” on a first mobile device (e.g., as a result of an ad request, Wi-Fi login, etc.), and may be observed at location “1b” on a second device (e.g., as part of an ad request from the second device). Location data for both of these events may be added to a single user profile for the user. The user profile may, for example, be linked to the user's multiple mobile devices.

In another example, a second user may be observed on a weekday at 2:30 PM at location “2a,” in the backyard of residence A 1702. The second user may also be observed at 11 PM on a weekday at location “2b,” inside a house at residence C 1706. Because the second user was observed at two residential locations (e.g., residence A 1702 and residence C 1706), location-based rules may be applied to determine which household the second user is a member. For example, a location-based rule may specify that a user's presence at a location at night weighs more heavily than the user's presence at the location during the day in determining the user's household. This example location-based rule may be based on the presumption that a person is likely to be at their own residence late at night (e.g., in bed sleeping). Applying this example rule, the second user (e.g., the second user's profile) may be determined to be associated with residence C 1706 (e.g., a member of the residence C 1706 household) rather than residence B 1704.

In a further example, a third user may be observed on a weekday at 11 AM on a sidewalk in front of residence A 1702. Based on the accuracy and/or precision of the location boundary of residence A 1702 and/or the observed location of the third user (e.g., in GPS coordinates received from the third user's mobile device), it may be determined that the third user is in front of residence A 1702 on the sidewalk rather than in the closely adjacent front yard within the location boundary of residence A 1702. The third user may also be observed once at 12 PM on a weekday at location “3b,” inside a house located at residence B 1704. This may be the only time the third user is observed to be within the location boundary of residence B 1704 over a period of time (e.g., one month). Location-based rules may be applied to determine, for example, whether the third user is a member of residence A 1702 and/or residence B 1704. For example, certain location-based rules may specify that a user who is observed at a location less than ten times per month is likely not associated with the defined location. Applying this rule, it may be determined that the third user is not a member of the residence B 1704 household because the third user was only observed at residence B 1704 one time over a month. The third user may also be determined not to be a member of residence A 1702 because the third user was merely observed on the sidewalk in front of residence A 1702 and not within its boundary. In this case, it may be determined that the third user is not associated with either residence A 1702 or residence B 1704.

In various embodiments, an association between a user profile and a defined location may be updated over time. For example, if after a certain time the first user is not observed at residence A 1702 for a period of, e.g., one month, it may be determined (e.g., based on location-based rules) that the first user is no longer associated with residence A 1702 (e.g., no longer lives at residence A 1702). And in this case, the first user's profile may be updated to reflect that the first user is no longer affiliated/associated with residence A 1702. By way of another example, an increased presence of a user at a defined location, with which the user was not previously associated, may indicate that the user is now associated with the location, and the user's profile may be updated accordingly.

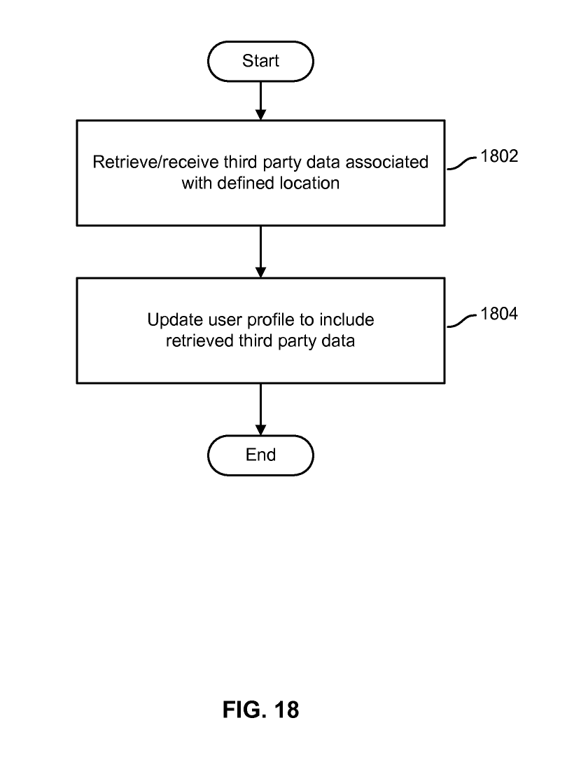

FIG. 18 is a flow chart illustrating embodiments of a process to update a user profile. Upon a determination that a user profile is associated with a defined location (e.g., a residential location), an identifier associated with a defined location (e.g., a postal address) may be determined for a user and/or stored in the user's profile. This location identifier may be used to identify/select third party data to be added to the user's profile. In the example shown, third-party data associated with a defined location may be received/retrieved (1802). Third-party data may, for example, be retrieved from a company that gathers data about users, including without limitation offline transaction data, survey data, and/or other data. Offline transaction data may include data regarding a user's purchases, behavior, and/or other interactions with a retail location. For example, offline transaction data associated with a user may include items purchased, types/categories of items purchased, frequency of purchases, times associated with purchases, purchase patterns, and/or other information gathered by a retail location. Offline transaction data associated with a retail location may be collected based on, for example, data from credit cards, loyalty cards, coupons, mobile application-based loyalty programs, and/or other purchase data collection approaches. Third party data may be stored and/or indexed by postal address, APN, phone number, and/or other identifier associated with a user. For example, a third party data collector may know a user's postal address, phone number, and/or other information based on, for example, credit registration information, loyalty card registration information, information received from a user, and/or other sources of information. By way of example, third party offline transaction data associated with a user may indicate the user resides at 123 Main St., is a female, and shops at a high-end grocery store where she buys organic foods and/or over-indexes on vegetables (e.g., buys more vegetables than an average consumer).

According to some embodiments, a user profile may be updated (1804) to include third party data. As discussed above, a user may be determined to be associated with a defined location, and an identifier of the defined location may, for example, be stored in the user's profile. The defined location identifier (e.g., address, phone number, APN, etc.) in the user's profile may be used to identify third party data, and the user profile may be updated to include the third party data. For example, a user profile may include information indicating that the user resides at 123 Main St. Based on this address information third party data associated with 123 Main St. may be identified and/or the user profile may be updated to include the third party data. In this example, user attributes in a user profile derived from, for example, the user's location patterns may reveal that a user fits a classification of an “active lifestyle parent.” This classification may be based, for example, on behavioral data indicating the user commonly visits a gym, city parks, and healthy restaurants. The third party data may including offline transaction data indicating that the user shops at high-end grocery stores, buys organic foods, and/or over-indexes on vegetables may be added to the “active lifestyle parent” user profile. By combining third party data and user attribute data derived from a user's observed location patterns, the accuracy of the user profile may be enhanced. For example, the user profile for the “active lifestyle parent” may be enriched to include the offline transactional data associated with user's purchase behavior at the high-end grocery store.

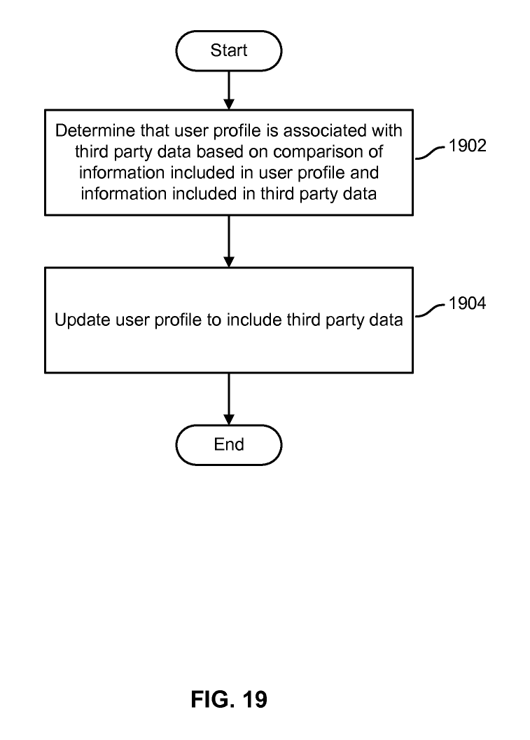

FIG. 19 is a flow chart illustrating embodiments of a process to update a user profile. In the example shown, it may be determined (1902) that a user profile is associated with third party data based on a comparison of information included in the user profile and information included in third party data. To confirm that the third party data is associated with the user profile, information included in the user profile may be compared to information included in the third party data. By way of example, a user profile may include user attribute data indicating that the user has recently visited a gym, a city park, a coffee shop, and a gas station. The user profile may also indicate that the user resides at 123 Main St. Meanwhile, third party credit card data associated with a user residing at 123 Main St. may include charges to the gym, coffee shop, and gas station. Based on a comparison of the user attribute data and the third party credit card data, it may be determined that user associated with the user profile and the third party data are the same user and/or related users (e.g., family members). In various embodiments, the user profile may be updated (1904) to include the third party data. Based on a determined match/correspondence between information included in the user profile and the third party data, the user profile may be updated to include the third party data.

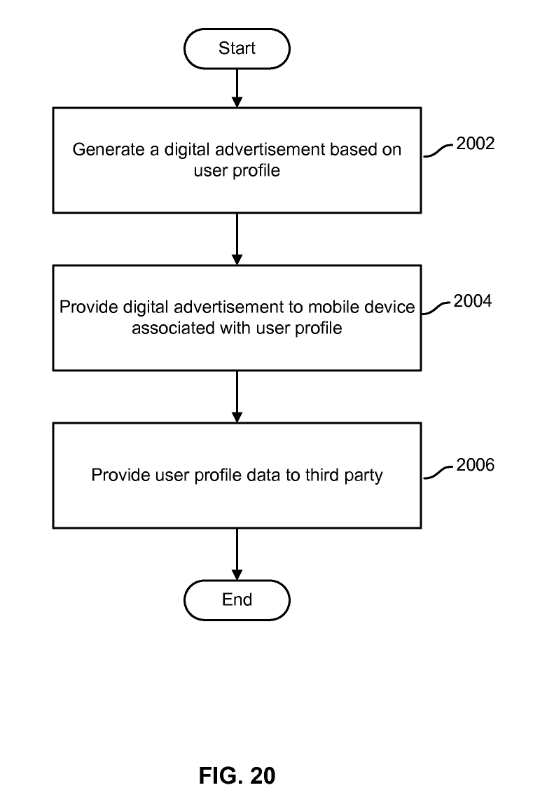

FIG. 20 is a flow chart illustrating embodiments of a process of providing user profile data to a third party. In the example shown, a digital advertisement may be generated (2002) based on a user profile. For example, a user profile may include user attribute data determined based on user's location patterns and third-party data (e.g., offline transaction data) associated with the user. And the user profile may be used to generate a digital advertisement. The digital advertisement may be provided (2004) to a mobile device associated with the user profile. For example, the digital advertisement may be provided to the mobile device in response to an ad request from the mobile device. In various embodiments, the user's profile may be updated to include a record of the served digital advertisement.

In some embodiments, the user profile data may be provided (2006) to a third party. For example, the user profile data may be output to an advertising content provider to assess the effectiveness of an advertising campaign. In various embodiments, the user profile provided to the third party (e.g., advertising content provider) may include a record of the digital advertisement, the user's location-based attributes before and/or after exposure to the digital advertisement, and offline transactional data for the user before and/or after exposure to the digital advertisement. This information may be used to, for example, evaluate the effect, if any, of the digital advertisement on the user's behavior.

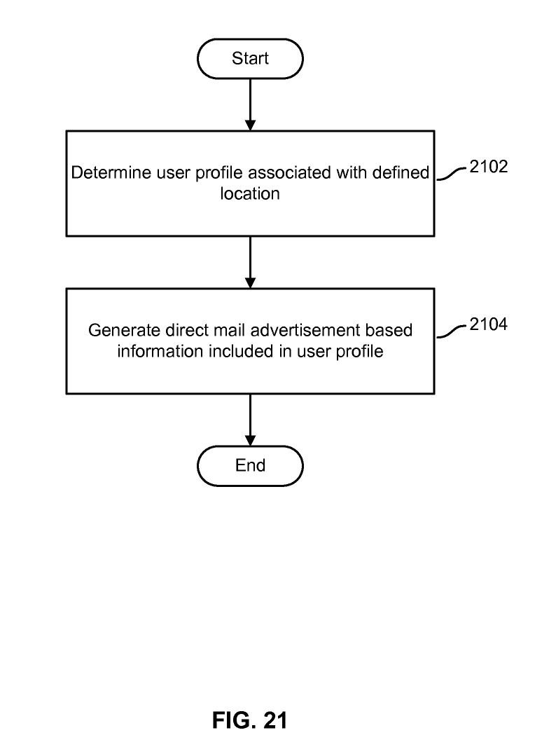

FIG. 21 is a flow chart illustrating embodiments of a process of generating a direct mail advertisement. In the example shown, a user profile associated with a defined location may be determined (2102). In various embodiments, a direct mail advertiser and/or other entity may request user profile information by providing information identifying a defined location (e.g., an address, APN, PIN, phone number, etc.). And the information identifying a defined location may be used to determine a user profile.

A direct mail advertisement may be generated (2104) based on a user profile. In various embodiments, information included in a user profile (e.g., demographic, behavioral, and/or other attributes) may be used to determine content for inclusion in a direct mail advertisement. In some embodiments, any information in a user profile joined using the household matching techniques discussed herein may be used to generate content for a direct mail campaign. In one example, attributes in a user profile determined based on a user's location data, attributes from third party data sources, and/or any other data may be used to determine advertising content for inclusion in a direct mail advertisement. In one example, a user profile may indicate that a user is female, 30-40 years old, owns a house purchased in 2010, and is a mother of an infant. These and/or other data may be used to determine content for a direct mail advertisement. For example, the direct mail advertisement may be generated to include content likely to be of interest to a person matching the attributes included in the user profile (e.g., female, 30-40 years old, owns a house purchased in 2010, mother of infant, etc.). In some embodiments, the direct mail advertisement may then be sent to an address associated with the user profile. For example, the direct mail advertisement may be sent to an anonymous recipient at the address.

In various embodiments, an identifier associated with a defined location (e.g., address) included in a user profile may be used to match the user profile data with direct mail providers. Once matched, the direct mail providers may send physical advertising to anonymous residents associated with the address.

Techniques disclosed herein enable the intersection of users, their locations, and/or their offline transaction patterns to be used to assign users to audience segments, enabling content more likely to be of interest to a particular user, such as mobile ads, to be provided.

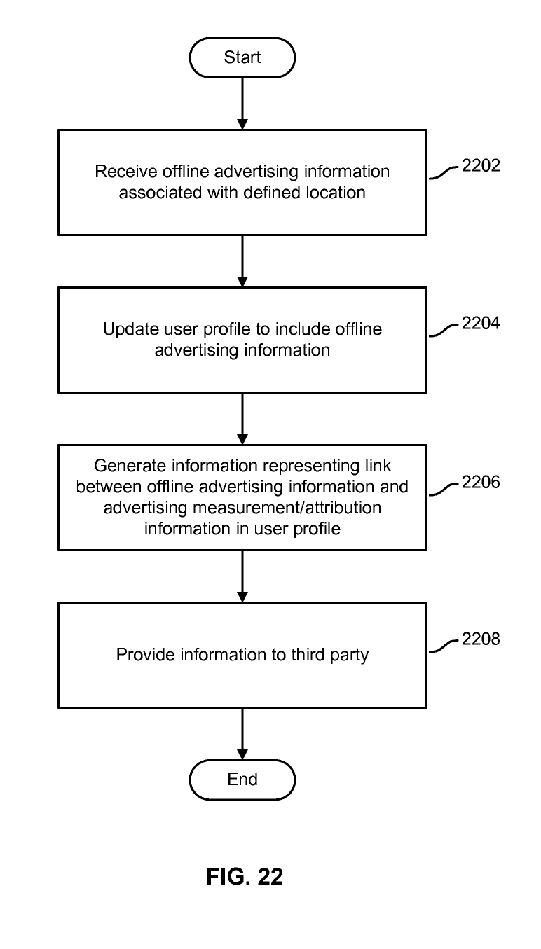

FIG. 22 is a flow chart illustrating embodiments of a process of linking offline advertising information and advertising measurement/attribution information. In the example shown, offline advertising information associated with a defined location may be received (2202). Offline advertising information may include, for example, the results of a physical marketing campaign (e.g., a physical, real-world advertising campaign). A physical marketing campaign may include direct-mail advertising, print advertising, and/or another type of marketing campaign. In various embodiments, it may be determined that offline advertising information is associated with a defined location (e.g., a household). This determination may be based on, for example, an address associated with the offline advertising information (e.g., an address to which a direct mail advertisement was sent).

In various embodiments, a user profile may be updated (2204) to include offline advertising information. Based on, for example, a determined match/correspondence between the offline advertising information (e.g., an address associated with the offline advertising information) and information included in the user profile (e.g., an address), the user profile may be updated to include the offline advertising information. For example, the offline advertising information may include the content included in an advertisement, an entity (e.g., business) associated with an advertisement, date(s) on which the advertisement was sent to a user (e.g., mailed to the defined location), and/or any other information associated with an offline advertisement (e.g., direct mail advertisements).

Information representing a link between offline advertising information and advertising measurement/attribution information in the user profile may be generated (2206). In various embodiments, offline advertising information may be matched to digital advertising measurement and/or attribution information. For example, offline advertising information (e.g., a direct mail campaign) associated with an entity (e.g., a business, organization, etc.) may be matched to information in a user profile representing interaction (e.g., views) associated with websites and/or applications also associated with the entity. Based on any determined matches, information representing a link/correlation between an entity's offline advertising information and a user's digital advertising views (e.g., views after receiving the offline advertisement) may be generated. For example, the information may include a number of visits to web pages and/or applications associated with the entity after a household associated with the user has received offline advertising information associated with the entity (e.g., direct mail advertisements for a business). This information may provide a measurement and/or level of attribution representing how effective an entity's offline advertising campaign is in driving the user to web pages, applications, and/or other digital content also associated with the entity.

In some embodiments, offline advertising information may be matched to offline transaction and/or purchase measurement/attribution data. For example, offline advertising information (e.g., a direct mail campaign) associated with an entity (e.g., a business, organization, etc.) may be matched to information in a user profile representing a user's offline transactions and/or purchase data. As discussed above, a user profile may have been updated to include offline transaction/purchase data representing a user's transactions and/or purchases at a physical retail location (e.g., a big box retailer, grocery store, etc.). A user's offline transaction and/or purchase data may have been matched to an address associated with the user profile. And the user profile may have been updated to include the offline transaction and/or purchase data based on the match.

In various embodiments, a user's transaction and/or purchase data at a physical location associated with an entity (e.g., a business) may be matched to offline advertising information (e.g., direct mail advertisement information) also associated with the entity. Based on the determined match, information representing a link/correlation between an entity's offline advertising information and a user's offline transaction and/or purchase data may be generated. This information may provide a measurement and/or level of attribution representing how effective an entity's offline advertising campaign is in driving the user to execute offline transactions/purchases at the entity's physical locations.

According to various embodiments, offline advertising information may be matched to foot-traffic conversion data. For example, offline advertising information (e.g., a direct mail campaign) associated with an entity (e.g., a business, organization, etc.) may be matched to location information in a user profile representing a user's foot traffic (e.g., visits) to a location associated with the entity. Based on the determined match, information representing a link/correlation between an entity's offline advertising information and a user's foot traffic to a location may be generated. This information may provide a measurement and/or level of attribution representing how effective an entity's offline advertising campaign is in driving a user to visit business locations (e.g., retail location, restaurant, etc.) associated with the entity. In various embodiments, the information may represent a lift in foot-traffic to the location resulting from (e.g., attributed to) the offline advertising information. For example, the information may include a Location Conversion Index™ associated with the offline advertising information (e.g., resulting from the direct mail campaign).

In various embodiments, the information representing a link between offline advertising information and advertising measurement/attribution information in a user profile may be provided (2208) to, for example, a third party. For example, the information may be provided to a third party (e.g., entity, business) associated with the offline advertising information (e.g., direct mail advertisement).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving, in a computing device, parcel data having a digital representation of boundaries separating and defining a plurality of parcels of land, wherein each of the parcels is a defined residential location;
receiving, in the computing device, location data of a mobile device, the location data including coordinates of the mobile device in a geo-coordinate reference system;
mapping the coordinates of the mobile device to a parcel of land based on the digital representation of boundaries of a plurality of parcels of land;
identifying, by the computing device, the parcel as a defined location among a plurality of defined residential locations based on the mapping of the coordinates;
determining, by the computing device, times of presence of the mobile device at the defined location and frequency of presence of the mobile device at the defined location based on the mapping of the location data to the location boundary of the defined location defined by the parcel data;
applying, by the computing device, a plurality of location-based rules based at least on the times of presence of the mobile device at the defined location and the frequency of presence of the mobile device at the defined location; and
determining, by the computing device based on the applying of the location based rules, that a user of the mobile device having a user profile, generated based on the location data of the mobile device, has a household at the defined location.

2-3. (canceled)

4. The method of claim 1, wherein the defined location comprises a first defined location; and the method further comprises: identifying, by the computing device, a second defined location among the defined residential locations based on mapping at least a portion of the location data of the mobile device to a second location boundary of the second defined location defined by the parcel data.

5. The method of claim 4, further comprising:
determining a first context associated with the mapping of the location data to the first defined location;
determining a second context associated with the mapping of the location data to the second defined location; and
determining based at least in part on one or more of the first context, the second context, and the location-based rules that the user of the mobile device has a household at the first defined location.

6. The method of claim 1, wherein the defined location includes a multi-unit defined location, the method further comprising:
determining that the user of the mobile device has the household at a particular one unit of the multi-unit defined location.

7. The method of claim 6, wherein determining that the user of the mobile device has the household at the particular one unit is based on an internet protocol (IP) address of the mobile device in a wireless network associated with the unit.

8-10. (canceled)

11. The method of claim 1, wherein mapping the location data to the location boundary comprises:
mapping the location data to a grid location; and
determining that the grid location is within the location boundary associated with the household.

12. The method of claim 1, wherein the location-based rules include tiebreaker rules.

13-14. (canceled)

15. The method of claim 1, further comprising:
update the user profile to include third-party data associated with the defined location, wherein the third party data includes offline transaction data associated with the defined location.

16. The method of claim 15, wherein the third party data comprises one or more of purchase data associated with a credit card, purchase data associated with a loyalty card, purchase data associated with a retail location, demographic data, survey data, and behavioral data.

17-20. (canceled)

21. The method of claim 1, further comprising:
determining that a second device is associated with the defined location; and
updating the user profile to include information associated with the second device.

22. The method of claim 1, further comprising:
determining that a second profile is associated with the defined location, and updating the user profile to include information included in the second profile.

23. The method of claim 1, further comprising:
using probabilistic matching to match data included in the user profile to a predefined pattern; and
updating the user profile to include an attribute associated with the predefined pattern.

24-26. (canceled)

27. A system, comprising:
a processor; and
a memory coupled with the processor, wherein the memory is configured to provide the processor with instructions which when executed cause the processor to:
receive parcel data having a digital representation of boundaries separating and defining a plurality of parcels of land, wherein each of the parcels is a defined residential location;
receive location data of a mobile device, the location data including coordinates of the mobile device in a geo-coordinate reference system;
mapping the coordinates of the mobile device to a parcel of land based on the digital representation of boundaries of a plurality of parcels of land;
identify the parcel as a defined location among a plurality of defined residential locations based on the mapping of the coordinates;
determine times of presence of the mobile device at the defined location and frequency of presence of the mobile device at the defined location based on the mapping of the location data to the location boundary of the defined location defined by the parcel data;
apply a plurality of location-based rules based at least on the times of presence of the mobile device at the defined location and the frequency of presence of the mobile device at the defined location; and
determining, based on the applying of the location based rules, that a user of the mobile device having a user profile, generated based on the location data of the mobile device, has a household at the defined location.

28. A non-transitory computer readable storage medium storing computer instructions configured to instruct a computing device to perform a method, the method comprising:
receiving, in a computing device, parcel data having a digital representation of boundaries separating and defining a plurality of parcels of land, wherein each of the parcels is a defined residential location;
receiving, in the computing device, location data of a mobile device, the location data including coordinates of the mobile device in a geo-coordinate reference system;
mapping the coordinates of the mobile device to a parcel of land based on the digital representation of boundaries of a plurality of parcels of land;
identifying, by the computing device, the parcel as a defined location among a plurality of defined residential locations based on the mapping of the coordinates;
determining, by the computing device, times of presence of the mobile device at the defined location and frequency of presence of the mobile device at the defined location based on the mapping of the location data to the location boundary of the defined location defined by the parcel data;
applying, by the computing device, a plurality of location-based rules based at least on the times of presence of the mobile device at the defined location and the frequency of presence of the mobile device at the defined location; and
determining, by the computing device based on the applying of the location based rules, that a user of the mobile device having a user profile, generated based on the location data of the mobile device, has a household at the defined location.
